(19) United States
(12) Patent Application Publication
(10) Pub. No.: US 2025/0150696 A1
(43) Pub. Date: May 8, 2025

(54) THIN ON-SENSOR NANOPHOTONIC ARRAY CAMERAS

(71) Applicants: The Trustees of Princeton University, Princeton, NJ (US); University of Washington, Seattle, WA (US)

(72) Inventors: Praneeth Chakravarthula, Princeton, NJ (US); Johannes Emanuel Froch, Seattle, WA (US); Felix Heide, Princeton, NJ (US); Arka Majumdar, Seattle, WA (US); Jipeng Sun, Princeton, NJ (US)

(21) Appl. No.: 18/935,984

(22) Filed: Nov. 4, 2024

Related U.S. Application Data
(60) Provisional application No. 63/546,991, filed on Nov. 2, 2023.

(51) Int. Cl. H04N 23/55; H04N 23/69

(52) U.S. Cl. CPC H04N 23/55; H04N 23/69

(57) ABSTRACT

A flat nanophotonic computational camera, which employs an array of skewed lenslets (meta-optics) and a learned reconstruction approach is disclosed herein. The optical array is embedded on a metasurface that with a height of approximately one micron, is flat and sits on the sensor cover glass at approximately 2.5 mm focal distance from the sensor. A differentiable optimization method continuously samples over the visible spectrum and factorizes the optical modulation for different incident fields into individual lenses. A megapizel image is reconstructed from a flat imager with a learned probabilistic reconstruction method that employs a generative diffusion model to sample an implicit prior. A method for acquiring paired captured training data in varying illumination conditions is proposed. The proposed flat camera design is assessed in simulation and with an experimental prototype, validating that the method is capable of recovering images from diverse scenes in broadband with a single nanophotonic layer.

### CROSS-REFERENCE TO RELATED APPLICATIONS

This application claims benefit of priority of U.S. Patent Application No. 63/546,991 filed Nov. 2, 2023, entitled, “THIN ON-SENSOR NANOPHOTONIC ARRAY CAMERAS”. The entire contents and disclosures of this patent application is incorporated herein by reference in their entirety.

### GOVERNMENT INTEREST STATEMENT

This invention was made with government support under Grant No. IIS2047359 awarded by the National Science Foundation and W31P4Q-21-C-0043 awarded by the Defense Advanced Research Projects Agency (DARPA). The government has certain rights in the invention.

### BACKGROUND

### Field of the Invention

The present disclosure relates generally to optical equipment and image processing techniques.

### Background of the Invention

Commodity camera systems may rely on compound optics to map light originating from the scene to positions on the sensor where it gets recorded as an image. To record images without optical aberrations, i.e., deviations from Gauss' linear model of optics, typical lens systems introduce increasingly complex stacks of optical elements which are responsible for the height of existing commodity cameras. In this work, a need exists for providing improvements in the described camera arena and image processing field.

### SUMMARY

According to first broad aspect, the present disclosure provides an imaging system comprising: a metalens array camera having a central element; a reference camera having a reference camera sensor; and a beam splitter, wherein the beam splitter splits world light into two optical paths by 70% transmission and 30% reflection. The beam splitter is positioned at a 45° tilting angle, wherein the transmission path is incident of a center of the central element, wherein a center of the reference camera is positioned in the reflection path and a distance between the beam splitter and the reference camera sensor is adjusted to the same as that between the beam splitter and the metalens array camera. An optical center and an optical axis of the central element of the metalens array camera is aligned to an optical center and an optical axis of the reference camera. The metalens array camera and the reference camera are synchronized to capture scenes with a same timestamps.

According to second broad aspect, the present disclosure provides a method of designing an array over an image sensor comprising: applying a differentiable optimization method that continuously samples over a visible spectrum; factorizing an optical modulation for different incident fields into individual lenes of a nanophotonic imager having a learned array of metalenses for capturing a scene; measuring an array of images, each having a different field of view (FoV); and deconvolving the array of images and merging them together to form a wider FoV image.

### BRIEF DESCRIPTION OF THE DRAWINGS

The patent or application file contains at least one drawing executed in color. Copies of this patent or patent application publication with color drawing(s) will be provided by the office upon request and payment of the necessary fee.

The accompanying drawings, which are incorporated herein and constitute part of this specification, illustrate exemplary embodiments of the invention, and, together with the general description given above and the detailed description given below, serve to explain the features of the invention.

FIG. 1 illustrates a thin nanophotonic imager employing a learned array of metalenses according to one embodiment of the present disclosure.

FIG. 2 illustrates a lens as a combination of prisms according to one embodiment of the present disclosure.

FIG. 3 illustrates an ultra-thin and compact metalens array according to one embodiment of the present disclosure.

FIG. 4 illustrates an overview of probabilistic image reconstruction according to one embodiment of the present disclosure.

FIG. 5 is a schematic illustration showing a capture setup for paired data acquisition according to one embodiment of the present disclosure.

FIG. 6 illustrates a synthetic qualitative assessment of diffusion-based deconvolution according to one embodiment of the present disclosure.

FIG. 7 illustrates a synthetic assessment of thin cameras according to one embodiment of the present disclosure.

FIG. 8 is a graph showing the calculated MTF for different angles of incidence according to one embodiment of the present disclosure.

FIG. 9 illustrates sensor measurement of the Siemens Star calibration pattern according to one embodiment of the present disclosure.

FIG. 10 illustrates experimental evaluation of the proposed thin nanophotonic camera on broadband indoor scenes according to one embodiment of the present disclosure.

FIG. 11 illustrates experimental evaluation of the proposed thin nanophotonic camera on broadband outdoor scenes according to one embodiment of the present disclosure.

FIG. 12 illustrates an experimental assessment of 5×5 prototype lens according to one embodiment of the present disclosure.

### DETAILED DESCRIPTION OF THE INVENTION

### Definitions

Where the definition of terms departs from the commonly used meaning of the term, applicant intends to utilize the definitions provided below, unless specifically indicated.

It is to be understood that the foregoing general description and the following detailed description are exemplary and explanatory only and are not restrictive of any subject matter claimed. In this application, the use of the singular includes the plural unless specifically stated otherwise. It must be noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as disclosed embodiments as other forms, such as “include”, “includes,” and “included,” is not limiting.

For purposes of the present disclosure, the term “comprising”, the term “having”, the term “including,” and variations of these words are intended to be open-ended and mean that there may be additional elements other than the listed elements.

For purposes of the present disclosure, directional terms such as “top,” “bottom,” “upper,” “lower,” “above,” “below,” “left,” “right,” “horizontal,” “vertical,” “up,” “down,” etc., are used merely for convenience in describing the various embodiments of the present disclosure. The embodiments of the present disclosure may be oriented in various ways. For example, the diagrams, apparatuses, etc., shown in the drawing figures may be flipped over, rotated by 90° in any direction, reversed, etc.

For purposes of the present disclosure, a value or property is “based” on a particular value, property, the satisfaction of a condition, or other factor, if that value is derived by performing a mathematical calculation or logical decision using that value, property or other factor.

For purposes of the present disclosure, it should be noted that to provide a more concise description, some of the quantitative expressions given herein are not qualified with the term “about.” It is understood that whether the term “about” is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value.

### DESCRIPTION

While the invention is susceptible to various modifications and alternative forms, specific embodiment thereof has been shown by way of example in the drawings and will be described in detail below. It should be understood, however that it is not intended to limit the invention to the particular forms disclosed, but on the contrary, the invention is to cover all modifications, equivalents, and alternatives falling within the spirit and the scope of the invention.

In this work, disclosed embodiments investigate flat nanophotonic computational cameras as an alternative that employs an array of skewed lenslets and a learned reconstruction approach. The optical array is embedded on a metasurface that, at 700 nm height, is flat and sits on the sensor cover glass at approximately 2.5 mm focal distance from the sensor. To tackle the highly chromatic response of a metasurface and design the array over the entire sensor, disclosed embodiments propose a differentiable optimization method that continuously samples over the visible spectrum and factorizes the optical modulation for different incident fields into individual lenses. Disclosed embodiments reconstruct a megapixel image from the disclosed flat imager with a learned probabilistic reconstruction method that employs a generative diffusion model to sample an implicit prior. To tackle scene-dependent aberrations in broadband, disclosed embodiments propose a method for acquiring paired captured training data in varying illumination conditions. Disclosed embodiments assess the proposed flat camera design in simulation and with an experimental prototype, validating that the method is capable of recovering images from diverse scenes in broadband with a single nanophotonic layer.

### INTRODUCTION

Cameras have become a ubiquitous interface between the real world and computers with applications across domains in fundamental science, robotics, health, and communication. Although their applications are diverse, today's cameras acquire information in the same way they did in the 19th century: they focus light on a sensing plane using a stack of lenses that minimize deviations from Gauss's linear model of optics (Gauss 1843). In this paradigm, increasingly complex and growing sets of lenses are designed to record an image.

Since the microfabrication revolution in the last century brought miniaturized sensors and electronic chips, it is now these optical systems that dictate a camera's size and weight and prohibit miniaturization without drastic loss of image quality (Asif et al. 2016; Peng et al. 2016a; Stork and Gill 2014). For example, the optical stack of the iPhone 13 contains more than seven elements that make up the entire 8 mm of the camera length responsible for the camera bump. Unfortunately, attempts to use thinner single-element optics (Peng et al. 2016a; Stork and Gill 2014; Venkataraman et al. 2013), amplitude masks close to the sensor (Asif et al. 2016; Khan et al. 2020), or diffusers (Antipa et al. 2018; Kuo et al. 2017) instead of focusing optics have not been able to achieve the high image quality that conventional compound lens systems deliver.

The emerging field of nanophotonic metaoptics suggests an alternative. These optical devices rely on quasi-periodic arrays of subwavelength scatterers that are engineered to manipulate wavefronts. In principle, this approach promises new capabilities to drastically reduce the size and weight of these elements. The unprecedented ability to engineer each nanoscatterer enables optical functionality that is extremely difficult, if not impossible, to achieve using conventional optics: spectral and spatial filters (Camayd-Muñoz et al. 2020), polarization imagers (Arbabi et al. 2018), compact hyperspectral imagers (Faraji-Dana et al. 2019), depth sensors (Colburn and Majumdar 2020), and even image processors (Zhou et al. 2020). Moreover, these flat optical elements are ultrathin, with a device thickness around an optical wavelength.

The imaging performance of existing metaoptics, however, is far from that of their refractive counterparts lenses (Colburn and Majumdar 2020; Tseng et al. 2021a). While these lenses are corrected for wavelengths across the visible regime, the image quality is not on par with refractive lenses: third-order Seidel aberrations (e.g., coma, field curvature, and distortion) remain uncorrected as they are not even considered in the design procedure for these devices. Furthermore, the small apertures of the metalenses used (50-100 μm) severely limit the achievable angular resolution and total light collection (reducing the signal-to-noise ratio).

Increasing the field of view and aperture of these metalenses while simultaneously maintaining and improving aberration correction faces fundamental challenges: metasurfaces are inherently chromatic like any diffractive optics. For a metalens designed for a specific wavelength, the positions of the rings of constant phase decides the lens focusing behavior. When the incident wavelength changes, however, the imparted phase exhibits erroneous phase-wrapping discontinuities that vary significantly from the ideal response expected for the incident, non-design wavelengths (Arbabi et al. 2016); this is the primary reason why metasurfaces exhibit chromatic aberrations. Recently, dispersion engineering has been investigated to design a metasurface to uniformly focus light across the full visible wavelength range (Chen et al. 2018; Wang et al. 2018a). This technique relies on designing scatterers with not only a desired phase but also its higher-order response in the form of group delay and group delay dispersion. Recent work finds that there is a fundamental limit on the optical bandwidth for a dispersion-engineered metalens given a feasible aspect ratio and, therefore, small lens thickness—a limit that arises from the inherent time-bandwidth product (Presutti and Monticone 2020a). The most successful approach to broadband imaging with metasurface optics from Tseng et al. (Tseng et al. 2021a) relies on end-to-end computational imaging and jointly designs lens parameters and computational reconstruction (Peng et al. 2019a; Sitzmann et al. 2018) with a differentiable forward model. Despite achieving increased image quality, the design limitations and computational and memory consumption of this approach is also fundamentally limited to designing nanophotonic optics with a limited field of view of 40°, optimized for narrow wavelength bands, and low image resolutions of a few kilopixels (Tseng et al. 2021a). Disclosed embodiments aim to tackle this issue and design broadband computational nanophotonic cameras that can lift this limitation and make thin cameras possible, more than two orders of magnitude thinner and lighter than today.

In this work, disclosed embodiments propose a flat camera that relies on an array of nanophotonic optics, which are learned for the broadband spectrum, and a computational reconstruction module that recovers a single megapixel image from the array measurements. The camera employs a single flat optical layer sitting on top of the sensor cover glass at approximately 2.5 mm focal distance from the sensor. Disclosed embodiments introduce a differentiable forward model that approximates the highly chromatic wavefront response of a metasurface atom conditioned on the structure parameters in a local region. Instead of full-wave simulation methods that do not allow for simulating apertures larger than tens of microns across the visible band due to prohibitive memory and computational requirements, this differentiable model allows one to piggy-back on distributed machine learning methods and learn nanophotonic imaging across the entire band by stochastic gradient optimization over the continuous spectrum—in contrast to Tseng et al. (Tseng et al. 2021a) who optimize over the three fixed wavelengths of an OLED display. Disclosed embodiments achieve high-quality imaging performance across the entire visible band and more than double the field of view of existing approaches to approximately 100° by separating the optical modulation for different optical fields into individual lenses in an array. Disclosed embodiments recover a latent image from the disclosed flat imager with a learned optimization method that relies on a diffusion model as a natural image prior. To tackle reconstruction in broadband illumination, disclosed embodiments introduce a novel method to capture large datasets of paired ground-truth data in real-world illumination conditions.

Specifically, disclosed embodiments make the following contributions: (1) Disclosed embodiments introduce a flat on-sensor nanophotonic array lens that decomposes the joint optimization over field angle and broadband focusing into several subproblems with several smaller field of view. Disclosed embodiments propose a stochastic optimization method for designing the decomposed broadband array elements. (2) Disclosed embodiments propose a novel learned probabilistic reconstruction method that relies on the physical forward model combined with a learned diffusion model as prior. To train the method, disclosed embodiments propose an approach to capture paired real-world datasets. Disclosed embodiments analyze the disclosed method in simulation and compare the proposed method to alternative flat optical systems. (3) Disclosed embodiments assess the method with a prototype camera system and compare it against existing metasurface designs. Disclosed embodiments confirm that the method achieves favorable image quality compared to existing metasurface optics across the entire spectrum and with a large field of view with a flat optical system on the sensor cover glass. Disclosed embodiments will release all code, optical design files, and datasets.

Limitations. Compared to traditional cameras with larger optical systems, the proposed flat camera shares with existing computational flat cameras the need for GPU processing with high power consumption. Despite this limitation, the compute resources on modern smartphones present opportunities for the efficient implementation of the proposed reconstruction method on custom ASICs, potentially enabling fast inference on edge devices in the future. The disclosed prototype does not use the full available optical aperture. To avoid optical baffles and overlap, disclosed embodiments space out the sublenses in the array over non-contiguous regions, resulting in low total light efficiency. Disclosed embodiments also do not explicitly consider fabrication inaccuracies.

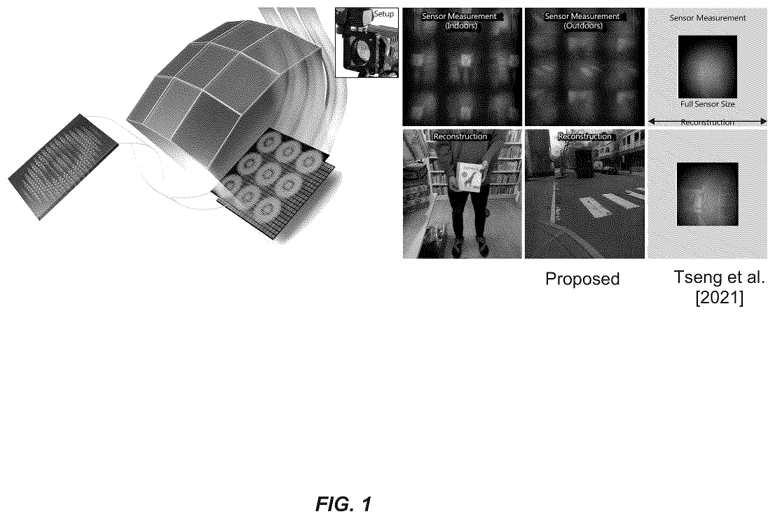

Turning to FIG. 1, disclosed embodiments propose a thin nanophotonic imager that employs a learned array of metalenses to capture a scene in-the-wild. Disclosed embodiments devise an array of lenses mounted directly on top of the sensor cover glass (top center). Each lens in the disclosed array (illustrated on the left) is a flat (700 nm thick) metasurface area of nano-antennas which disclosed embodiments design to focus light across the visible spectrum. The peripheral elements capture images at slanted field angles, making it possible to capture a wide field of view of approximately 100°, more than twice as large as the most similar design from Tseng et al. (2021a) shown on the right side. The proposed computational camera is capable of recovering images outside of lab conditions under broadband illumination. Disclosed embodiments illustrate here the matching physical image size as measured on the sensor, with the gray area on right illustrating same sensor size.

### Related Work

Flat Computational Cameras. Researchers have investigated several directions to reduce the height and complexity of existing compound camera optics. A line of work aims at reducing a complex optical stack of a handful to a dozen elements, to a single refractive element (Heide et al. 2013; Li et al. 2021; Schuler et al. 2013; Tanida et al. 2001) resulting in geometric and chromatic aberrations. Trading optical for computational complexity to address the introduced aberrations, these approaches have achieved impressive image quality comparable to a low-resolution point-and-shoot camera. Venkataraman et al. (2013) suppress chromatic aberrations by using an on-sensor array of color-filtered single lens elements, which turns the deconvolution problem into a chromatic light field reconstruction approach that is challenging to solve without artifacts. All proposed single-element refractive and diffractive cameras (Heide et al. 2016; Peng et al. 2015, 2016b) have in common that, although the optical stack itself decreases in height (less than a micron for diffractive elements), they require long backfocal distances of more than 10 mm prohibiting thin cameras. Lensless cameras (Antipa et al. 2018; Asif et al. 2016; Khan et al. 2020; Kuo et al. 2017; Liu et al. 2019; Monakhova et al. 2020; White et al. 2020) instead replace the entire optical stack with amplitude masks or diffusers that scramble the incoming wavefronts. Although this approach allows for thin cameras of a few millimeters in height, the information of a given scene point is distributed over the entire sensor. The light efficiency of these cameras is half of that of conventional lens systems, and recovering high-quality images from the coded measurements with large point spread functions of global support is challenging and, as such, the ill-posedness of the underlying reconstruction problem severely limits spatial resolution and requires long acquisition times. Using diffusers as caustic lenses has been investigated for 2D photography (Kuo et al. 2017), 3D imaging (Antipa et al. 2018) and microscopy (Kuo et al. 2020). In addition to resulting in a challenging ill-posed reconstruction problem, the optimal distance from the diffuser to the sensor may vary from one diffuser to another (Boominathan et al. 2020). In this work, disclosed embodiments investigate an array of steered metasurface lenses as an alternative that allows for a short backfocal distance without mandating aberrations with global support or reducing light efficiency.

TABLE 1
Comparison of related work on thin cameras, where each criterion
is fully ✓, partially (✓), or not X met. See text for discussion.

| FlatCam | DiffuserCam | PiCam | Peng et al. | Tseng et al. | |
|---|---|---|---|---|---|
| (2016) | (2017) | (2013) | (2016) | (2021a) | Ours |

Camera Charateristics

| | | | | | | |
|---|---|---|---|---|---|---|
| On-Sensor (<2 mm) | ✓ | (✓) | ✓ | X | ✓ | ✓ |
| Light Efficiency | X | (✓) | (✓) | ✓ | X | ✓ |
| Broadband | ✓ | ✓ | ✓ | (✓) | (✓) | ✓ |
| Wide Field of View | (✓) | (✓) | (✓) | X | (✓) | ✓ |
| MTF | X | X | (✓) | ✓ | X | ✓ |
| Fabrication | ✓ | (✓) | | X | ✓ | ✓ |
| Well-posedness | X | X | (✓) | (✓) | (✓) | ✓ |

Metasurface Optics. Over the last few years, recent advancements in nanofabrication have made it possible for researchers to investigate optics by using quasi-periodic arrays of subwavelength scatterers to modify incident electromagnetic radiation. These ultra-thin metasurfaces allow the fabrication of freeform surfaces using single stage lithography. Specifically, meta-optics can be fabricated by piggy-backing on existing chip fabrication processes, such as deep ultraviolet lithography (DUV), without error-prone multiple etching steps required for conventional diffractive optical elements (Shi et al. 2022). Each scatterer in a metasurface can be independently tailored to modify amplitude, phase, and polarization of wavefronts-light can be modulated with greater design freedom compared to conventional diffractive optical elements (DOEs) (Engelberg and Levy 2020; Lin et al. 2014; Mait et al. 2020; Peng et al. 2019b). With these theoretical advantages in mind, researchers have investigated flat meta-optics for imaging (Aieta et al. 2012; Colburn et al. 2018; Lin et al. 2021; Yu and Capasso 2014), polarization control (Arbabi et al. 2015), and holography (Zheng et al. 2015). However, existing meta-optics suffer from severe chromatic and geometric aberrations making broadband imaging outside the lab infeasible with existing designs. In contrast to diffractive optics, the wavelength-dependent aberrations are a direct result from non-linear imparted phase (Aieta et al. 2015; Lin et al. 2014; Wang et al. 2018b; Yu and Capasso 2014). While methods using dispersion engineering (Arbabi et al. 2017; Khorasaninejad et al. 2017; Ndao et al. 2020; Shrestha et al. 2018; Wang et al. 2017) are successful in reducing chromatic aberrations, these methods are limited to aperture sizes of tens of microns (Presutti and Monticone 2020b). Most recently, Tseng et al. (Tseng et al. 2021a) have proposed an end-to-end differentiable design approach for meta-optics that achieves full-color image quality with a large 0.5 mm aperture. However, while successful in imaging tri-chromatic bands of an OLED screen, their method does not perform well outside the lab and suffers from severe blur for fields beyond 40°. Recent advanced nano fabrication techniques have also made compact conventional cameras with wafer-level compound optics possible, e.g., OVT CameraCube (https://www.ovt.com/technologies/cameracubechip/) which, however, offers limited resolution and FoV. The proposed array design in this work optimizes image quality over the full broadband spectrum across the 100° deg FoV without increasing the backfocal length. The disclosed method can potentially allow for one-step fabrication of the metalens directly on the camera sensor coverglass in the future, further shrinking existing wafer-level multi-element compound lens camera designs.

Differentiable Optics Design. Conventional imaging systems are typically designed in a sequential approach, where the lens and sensors are hand-engineered concerning specific metrics such as RMS spot size or dynamic range, independently of the downstream camera task. Departing from this conventional design approach, a large body of work in computational imaging has explored jointly optimizing the optics and reconstruction algorithms, with successful applications in color image restoration (Chakrabarti 2016; Peng et al. 2019c), microscopy (Horstmeyer et al. 2017; Kellman et al. 2019; Nehme et al. 2020; Shechtman et al. 2016), monocular depth imaging (Chang and Wetzstein 2019; Haim et al. 2018; He et al. 2018; Wu et al. 2019), super-resolution and extended depth of field (Sitzmann et al. 2018; Sun et al. 2021), time-of-flight imaging (Chugunov et al. 2021; Marco et al. 2017; Su et al. 2018), high-dynamic range imaging (Metzler et al. 2020; Sun et al. 2020), active-stereo imaging (Baek and Heide 2021), hyperspectral imaging (Baek et al. 2021), and computer vision tasks (Tseng et al. 2021b). In this work, disclosed embodiments take a hybrid approach wherein disclosed embodiments first optimize a nanophotonic lens array camera, designed with an inverse filter as an efficient proxy for the reconstruction method. Disclosed embodiments then devise a novel probabilistic deconvolution method conditioned on the measured signals for full-color image restoration, computationally compensating residual aberrations.

### Nanophotonic Array Camera

In this section, disclosed embodiments describe the nanophotonic array camera for thin on-sensor imaging. Disclosed embodiments design the imaging optic by learning an array of short back focal length metalenses with carefully designed phase profiles, enabling the camera to capture a scene with a large viewing angle. A learned image reconstruction method recovers the latent image from the nanophotonic array camera resulting in a thin on-chip imaging system. In the following, disclosed embodiments first describe the nanophotonic array optic. In the remainder of this section, disclosed embodiments then derive the differentiable image formation model for the metalens array which disclosed embodiments rely on to learn the phase profiles. In Sec. 4, disclosed embodiments describe the disclosed reconstruction method.

### Lens as a Combination of Prisms

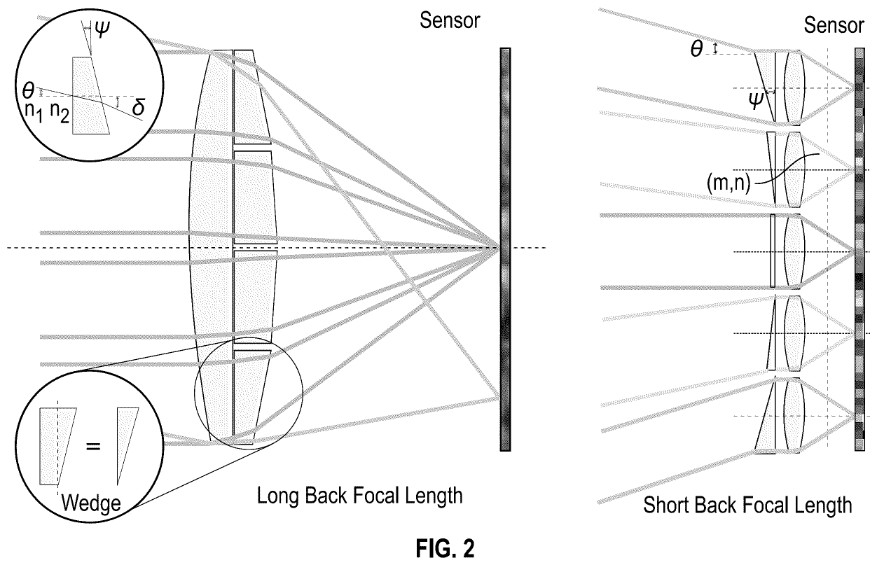

A lens can be thought of as analogous to a series of continuous prisms as shown in FIG. 2. A lens refracts an incoming set of parallel rays and bends them towards a focal point. With a piece-wise linear approximation, a lens can be thought of as stacked local, infinitesimally small, wedge prisms. Disclosed embodiments depart from a single large lens with long back focal length, reorganize the prisms, and represent a large lens as a combination of appropriately chosen wedges and lenses with short focal length for high-quality camera imaging.

A conventional prism refracts light causing its path to bend as

$$δ = θ - ψ + {sin}^{- 1} ( \sqrt{{n}^{2} - {sin}^{2} θ} sin ψ - sin θ cos ψ ) , \qquad ( 1 )$$

where n=n₂/n₁ is the relative refractive index, ψ is the disclosed wedge angle of the prism, θ is the angle of incident light and δ is the angle of deviation, illustrated in FIG. 2. The greater the disclosed wedge angle, the greater the deviation of light path is. For smaller wedge and incident angles, the angle of deviation can be approximated as

$$δ \approx ( n - 1 ) ψ . \qquad ( 2 )$$

Therefore, narrow-angle prisms in an imaging setup merely result in a shift in image position. Specifically, light passing through the optical center of a lens where the surfaces are parallel to each other yields no prismatic effect in the center. However, light passing through the periphery of a lens experiences prismatic effects. The increasing angle between the opposing surfaces further from the lens center causes light to bend more and more, allowing the lens to focus light. Therefore, stacking a series of tiny prisms effectively makes a lens, notwithstanding the presence of aberrations. However, since different wavelengths are refracted differently, a large angle prism also causes different wavelengths to spread out in the image, causing chromatic aberrations due to the spectrum of colors from white light, coma, and astigmatism.

In this work, disclosed embodiments design the disclosed optical layer as a combination of tiny co-optimized lens and prism phase elements, illustrated in FIG. 2, where the prisms help expand the field of view and the lenses reduce the back focal length. This allows devising a nanophotonic lens array to approximate the large lens, but trading off focal length with aberrations. Moreover, disclosed embodiments also optimize the lens to correct some of the dispersion-based aberrations caused by the prism phases.

### Radially Symmetric Nanophotonic Array

Nanophotonic meta-optics are ultrathin optical elements that utilize subwavelength nano-antenna scatterers to modulate incident light. Typically, these nano-antenna structures are designed for modulating the phase of incident light at a single nominal design wavelength, making meta-optics efficient for monochromatic light propagation. However, disclosed embodiments require the meta-optic to achieve the desired phase modulation at all visible wavelengths to design a broadband imaging lens.

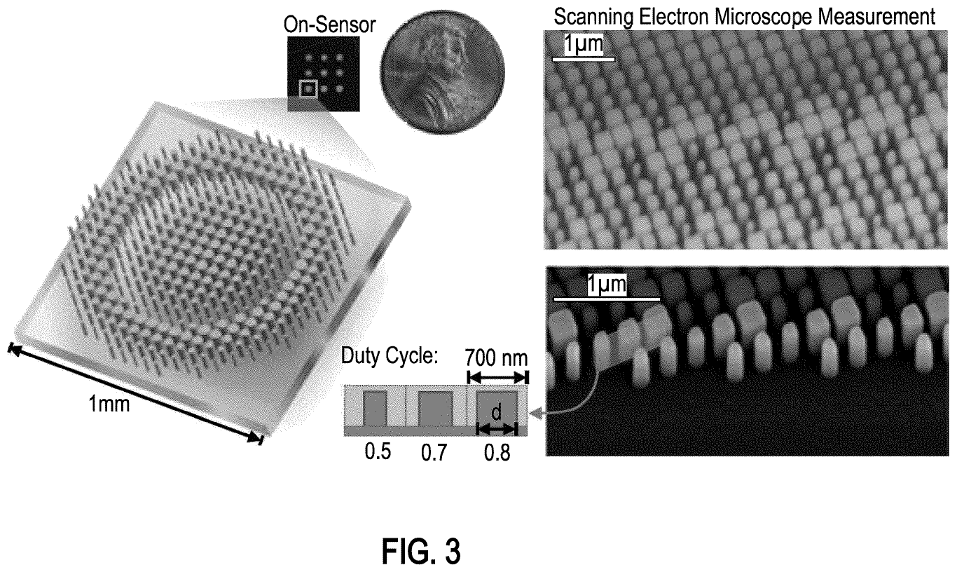

Metasurface Design Space. FIG. 3 illustrates an ultra-thin and compact metalens array according to one embodiment of the present disclosure. Disclosed embodiments may include an on-sensor imaging optic. The on-sensor imaging optic may be smaller than a penny and consist of an array of metalenses as shown. In some disclosed embodiments, each metalens may be made of optimized nano-antennas, for example, of size approximately 350 nm, significantly smaller than the wavelength of visible light. The disclosed optimized metalens nano-antenna structures scatter light from the entire visible spectrum.

Thus, disclosed embodiments may design metasurfaces that consist of silicon nitride nanoposts with a height of approximately 700 nm and a pitch of approximately 350 nm on top of a fused silica (n=1:5), see FIG. 3. The rectangular pillars are made of a high refractive index material that is transparent. Disclosed embodiments keep these parameters fixed and then optimize the width (=length) of the nano-antennas between 100-300 nm, determining what disclosed embodiments call the local “duty cycle,” see again FIG. 3.

In a local neighborhood of these nano-antennas, disclosed embodiments are able to simulate the phase for a given duty cycle using rigorous-coupled wave analysis (RCWA), which is a Fourier-domain method that solves Maxwell's equations efficiently for periodic dielectric structures. As such, in the following, disclosed embodiments characterize metalenses with their local phase, which disclosed embodiments tie to the structure parameters, i.e., the duty cycle, via a differentiable model.

Radially Symmetric Metalens Array. Disclosed embodiments model the metasurface phase φ, which disclosed embodiments treat as a differentiable variable in the disclosed design, as a radially symmetric per-pixel basis function

$$ϕ ( {x}_{i} , {y}_{j} ) = ϕ ( r ) , \qquad ( 3 )$$

$$r = \sqrt{{x}_{i}^{2} + {y}_{j}^{2}} , i , j ∈ \{ 1 , 2 , … , N \} ,$$

where N is the total number of pixels along each axis, xᵢ, yⱼ denotes the nano-antenna position and r is its distance from the optical along one radius of the metasurface to vary independently of the other nano-antennas without constraints. Disclosed embodiments constrain the metalens to be radially symmetric as opposed to optimizing the phase in a per-pixel manner to avoid local minima. Additionally, a spatially symmetric design imparts a spatially symmetric PSF which reduces the computational burden as it allows the simulation of the full field-of-view by only simulating PSFs along one axis.

Disclosed embodiments impose an additional wedge phase of varying wedge angles over each metalens element to achieve a wider field of view. Therefore, for an M×N nanophotonic array, the phase of each element is given by

$${ϕ}^{m , n} ( {x}_{i} , {y}_{j} ) = {ϕ}^{m , n} ( r ) = ϕ ( r ) + \frac{2 π}{{λ}_{w}} ( {x}_{i} sin {Ψ}_{x}^{m , n} + {y}_{i} sin {Ψ}_{y}^{m , n} ) , \qquad ( 4 )$$

where ϕ^{m,n}xᵢ, yⱼ is the phase modulation at the (xᵢ, yⱼ)-th nanoantenna of metalens in m-th row and n-th column, λ_{w} is the wavelength for which the wedge phase was defined, and (ψₓ, ψ_{y}) are the selected wedge angles along each axis. Note that for given wedge angles of a metalens element in the array, the additional wedge phase is constant whereas the radially symmetric phase is optimizable.

Since the phase is defined only for a single nominal design wavelength, disclosed embodiments apply two operations in sequence at each scatterer position in the disclosed metasurface: 1) a phase-to-structure inverse mapping to compute the scatterer geometry at the design wavelength for a given phase and 2) a structure-to-phase forward mapping to calculate the phase at other target wavelengths given a scatterer geometry. To allow for direct optimization of the metasurface phase, disclosed embodiments model both the above operators as polynomials to ensure differentiability, which disclosed embodiments describe below.

RCWA Proxy Mapping Operators. Disclosed embodiments describe the scatterer geometry with the duty cycle of nano-antennas and analyze its modulation properties using rigorous coupled-wave analysis (RCWA). The phase as a function of duty cycle of the nano-antennas must be injective to achieve a differentiable mapping from phase to duty cycle. To this end, disclosed embodiments fit the phase data of the metalens at the nominal design wavelength to a polynomial proxy function of the form

$$d ( r ) = {\sum }_{i = 0}^{N} {{a}_{i} ( \frac{ϕ ( r )}{2 π} )}^{2 i} , \qquad ( 5 )$$

where d(r) is the required duty cycle at a position r from the optical axis on the metasurface, ϕ(r) is the desired phase for the nominal wavelength λ₀, and the parameters aᵢ are fitted. Disclosed embodiments set the nominal wavelength λ₀=452 nm for all of the disclosed experiments.

After applying the above phase-to-scatterer inverse mapping to determine the required physical structure, disclosed embodiments compute the resulting phase from the given scatterer geometry for other wavelengths using a second scatterer-to-phase proxy function. This forward map ping function maps a combination of the nano-antenna duty cycle and incident wavelength to an imparted phase delay. Disclosed embodiments model this proxy function by fitting the pre-computed transmission coefficient of scatterers under an effective index approximation (Tseng et al. 2021a) to a radially symmetric second-order polynomial function of the form

$$\tilde{ϕ} ( r , λ ) = {\sum }_{n = 0}^{2} {\sum }_{m = 0}^{2} {b}_{nm} {d ( r )}^{n} {λ}^{m} , n + m \leq 2 , \qquad ( 6 )$$

where λ is a non-nominal wavelength. Specifically, disclosed embodiments compute the transmission coefficient data C_{META} using RCWA and then fit the polynomial to the underlying RCWA-computed transmission coefficient data using linear least squares.

Single Lens Element Image Formation. With the metalens phase described by Eq. (4) and the mapping operators defined in Eq. (5) and Eq. (6), disclosed embodiments compute the phase modulation for a broadband incident light. Using a fast Fourier transform (FFT) based band-limited angular spectrum method (ASM), disclosed embodiments calculate the PSFs produced by each metalens in the array as a function of wavelength and field angle to model full-color image formation over the entire field of view. The spatially varying PSF as produced by each element in the nanophotonic array for an incident beam of wavelength λ at an angle θ is

$${PSF}_{θ , λ}^{m , n} = {f}_{META} ( {ϕ}^{m , n} ( r ) , θ , {C}_{META} ) , \qquad ( 7 )$$

where ϕ^{m,n}(r) is the optimizable radially symmetric metasurface phase and C_{META} are the set of fixed parameters such as aperture and focal length of the metalens, and f_{META}(⋅) is the angular spectrum method as a propagation function that generates the PSF k for a given metasurface phase. Finally, the RGB image on the sensor plane is

$$S = I ⊗ k + {η}_{SENSOR} . \qquad ( 8 )$$

where ⊗ is a convolution operator, I is the groundtruth RGB image, and ηₛ is the sensor noise modeled as per-pixel Gaussian-Poisson noise.

Specifically, for an input signal x∈(0, 1) at a sensor pixel location, the measured noisy signal ƒₛₑₙₛₒᵣ(x) is given by

$${f}_{sensor} ( x ) = {η}_{g} ( x , {σ}_{g} ) + {η}_{p} ( x , {a}_{p} ) , \qquad ( 9 )$$

where n_{g}(x, σ_{g})˜N(x, σ_{g}²) is the Gaussian noise component and
ηₚ(x, aₚ)˜P(x/aₚ) is the Poisson noise component.

Spatially Varying Array Image Formation. Disclosed embodiments simulate the spatially varying aberrations in a patch-wise manner. Disclosed embodiments first divide the overall FoV into an M×N grid of patches for a nanophotonic array with M×N metalens elements. For incident broadband light at field angle θ, disclosed embodiments then compute PSF_{θ,λ} for each metalens element in the array with varying disclosed wedge angles, see Eq. 4. While disclosed embodiments use PSF_{θ,λ} for the image formation forward model, disclosed embodiments permute the PSFs for different wavelengths for deconvolution. This process acts as a regularization to the PSF design and avoids variance across the spectrum, essential for robust imaging in the wild. After design and fabrication, disclosed embodiments account for mismatches between the simulated PSF by the disclosed proxy model and the experimentally measured PSF by performing a PSF calibration step.

Differentiable Nanophotonic Array Design. With a measurement S as input, disclosed embodiments recover the latent image as

$${I}^{∼} = {f}_{DECONV} ( S , k , {C}_{DECONV} ) , \qquad ( 10 )$$

where C_{DECONV} are the fixed parameters of the deconvolution method. To make the disclosed lens design process efficient, disclosed embodiments employ an inverse filtering method in the design of the disclosed optic which does not require training and allows it to be computed in one step, as opposed to the proposed method in Sec.

With this synthetic image formation model in hand, the disclosed nanophotonic array imaging pipeline allows applying a first-order stochastic gradient optimization to optimize for the metalens phases that minimize the error between the ground truth and recovered images. In the disclosed case, given an input RGB image I, disclosed embodiments aim to find a metalens array that will recover I with high fidelity with short back focal length to achieve compact and ultra-thin imaging device with wide FoV. To design the disclosed optical system, disclosed embodiments minimize the per-pixel mean squared error and maximize the perceptual image quality between the target image I and the recovered image Ĩ. To this end, disclosed embodiments use first-order stochastic gradient descent solvers to optimize for individual metalens elements in the nanophotonic array as follows

$${\tilde{ϕ} ( r )}^{m , n} = {arg min}_{\{ ϕ \}} {\sum }_{i = 1}^{T} {\sum }_{θ , λ} ℒ ( {\tilde{I}}_{θ , λ}^{( t )} , {I}_{θ , λ}^{( i )} ) , \qquad ( 11 )$$

where T is the total number of training image samples and the images are measured by the m, n-th metalens in the array and the loss function

$$L = {L}_{MSE} + {L}_{LPIPS} \qquad ( 12 )$$

Specifically, disclosed embodiments design the metalens to work in the entire broadband visible wavelength range and modulate the incident wave fields over a 60° FoV. Disclosed embodiments notice that PSFs vary smoothly across the FoV and hence disclosed embodiments sample it in regular intervals of 15° during optimization, whereas the wavelengths are sampled in intervals of 50 nm over the visible range. Disclosed embodiments use the Adam optimizer with a learning rate of 0.001 running for 15 hours over the dataset described in Sec. 5 to optimize for the meta-optic phase. Disclosed embodiments further fine-tune the metalens phase to suppress side lobes in the PSF to eliminate the haze that corrupts the sensor measurements, especially the ones captured in the wild. Once the optimization is complete, disclosed embodiments use the optimized radially symmetric metalens with the appropriate disclosed wedge phases to manufacture the disclosed meta-optic.

Full Spectrum Phase Initialization. To aid the optimization from above, disclosed embodiments propose a full spectrum metalens phase initialization wherein a rotationally symmetric metalens phase is optimized to maximize the focal intensity at the center of the field of view. Specifically, disclosed embodiments initialize the optimization described in Eq. 11 with the solution to another optimization problem with the following objective

$$\tilde{ϕ} = {arg min}_{\{ ϕ \}} {\sum }_{λ = 400}^{700} - {f}_{META} ( ϕ , θ = 0 , {C}_{META} ) {\vert}_{( {x}_{s} , {y}_{s} ) = ( 0 , 0 )} . \qquad ( 13 )$$

where (xₛ, yₛ) are the coordinates on the sensor plane. In other words, the solution to the above optimization problem finds a metalens phase that focuses all broadband light energy at the center of the sensor plane, thereby significantly reducing chromatic artifacts. Disclosed embodiments sample the wavelengths in steps of 10 nm and further use a per-pixel error function on the computed PSF in order to further improve the phase initialization. Note that similar to the phase described in Eq. (3), disclosed embodiments use a per-pixel basis for solving the above metasurface phase which disclosed embodiments later use to initialize Eq. (11).

Finally, the phase obtained by solving the optimization problem described in Eq. (11) is fabricated and installed on the sensor of the prototype camera, see Sec. 5.2. The measurements by this ultra-thin compact camera follow Eq. (8), and disclosed embodiments next describe how the latent images are recovered.

### Probabilistic Image Recovery

This section describes how disclosed embodiments recover images from measurements of the on-sensor array camera. Disclosed embodiments first formulate the image recovery task as a model-based inverse optimization problem with a probabilistic sampling stage that samples a learned prior. Disclosed embodiments solve the optimization problem via splitting and unrolling into a differentiable truncated solver. To learn a natural image prior along with the unrolled solver, disclosed embodiments propose a probabilistic diffusion model that samples a multi-modal distribution of plausible latent images. For ease of notation, disclosed embodiments first describe the image recovery algorithm for a single lens element before describing the recovery method for the entire array.

### Model-Based Splitting Optimization for a Single Element

Disclosed embodiments propose a method to recover the latent image I from the sensor measurement S that relies on the physical forward model described in Eq. (8). Disclosed embodiments represent the spatially varying PSF of the array camera as k in the following for brevity. Following a large body of work on inverse problems in imaging (Bertero et al. 2021; Romano et al. 2017; Venkatakrishnan et al. 2013), disclosed embodiments pose the deconvolution problem at hand as a Bayesian estimation problem. Specifically, disclosed embodiments solve a maximum-a-posteriori estimation problem (Laumont et al. 2022) with an abstract natural image prior Γ(I), that is

$$\tilde{I} = {arg min}_{\{ I \}} {\underbrace{\frac{1}{2} {‖ I ⊗ k - S ‖}^{2}}}_{Data Fidelity} + {\underbrace{ρΓ ( I )}}_{Prior Regularization} , \qquad ( 14 )$$

where ρ>0 is a prior hyperparameter. However, instead of solving for the singular maximum of the posterior as a point estimate, disclosed embodiments employ a probabilistic prior that samples the posterior of all plausible natural image priors. In other words, this will sampling a multiple plausible reconstructions near the maximum.

To solve Eq. (14), disclosed embodiments split the non-linear and non-convex prior term from the linear data fidelity term to result in two simpler subproblems via half-quadratic splitting. To this end, disclosed embodiments introduce an auxiliary variable z, and pose the above minimization problem as

$${arg min}_{\{ I , z \}} \frac{1}{2} {‖ I ⊗ k - S ‖}^{2} + ρΓ ( z ) s . t . z = I . \qquad ( 15 )$$

Disclosed embodiments further reformulate the above minimization problem then as

$${arg min}_{\{ I , z \}} \frac{1}{2} {‖ I ⊗ k - S ‖}^{2} + ρΓ ( z ) + \frac{μ}{2} {‖ z - I ‖}^{2} , μ \to ∞ , \qquad ( 16 )$$

where μ>0 is a penalty parameter, that μ→∞ mandates equality I=z. Disclosed embodiments relax μ and solve the above Eq. (16) iteratively by alternating between the following two steps,

$$\{ \begin{matrix}{I}^{t + 1} = arg {min}_{\{ I \}} \frac{1}{2} {‖ I ⊗ k - S ‖}^{2} + \frac{{μ}^{′}}{{min}_{\{ I \}} 2} {‖ I - {z}^{t} ‖}^{2} , \\ {z}^{t + 1} = arg {min}_{\{ z \}} \frac{{μ}^{′}}{2} {‖ z - {I}^{t + 1} ‖}^{2} + ρΓ ( z ) .\end{matrix} \qquad ( 17 )$$

where t is the iteration index and μ^{t} is the updated weight in each iteration. Disclosed embodiments initialize the disclosed method with μ⁰=0.1 and exponentially increase its value for every iteration. Note that disclosed embodiments solve for I given fixed values of z from the previous iteration and vice-versa.

The first update from the iteration (17) is a quadratic term that corresponds to the data term from Eq. (14). Assuming circular convolution, it can be solved in closed form with the following inverse filter update

$${I}^{t + 1} = {ℱ}^{†} ( \frac{{ℱ}^{*} ( k ) ℱ S + {μ}^{t} ℱ ( {I}^{t} )}{{ℱ}^{*} ( k ) ℱ ( k ) + {μ}^{t}} ) , \qquad ( 18 )$$

where F(⋅) denotes the Fast Fourier Transform (FFT), F*(⋅) denotes the complex conjugate of FFT, and F^{†} denotes the inverse FFT.

However, the second update from iteration (17) includes the abstract regularizer and it is, in general, non-linear and non-convex. Disclosed embodiments learn the solution to this minimization problem with a diffusion model that allows disclosed embodiments to probabilistically sample the solution space near the current iterate I^{t+1}. Specifically disclosed embodiments sample from a distribution Ω that is conditioned on the iterate I^{t+1} and the optimization penalty weights ρ, μ as inputs

$${z}^{t + 1} ∼ Ω ( {I}^{t + 1} , ρ , {μ}^{t} ) \qquad ( 19 )$$

Next, disclosed embodiments describe how disclosed embodiments learn and sample from this prior in the disclosed method.

### Diffusion-Based Image Prior

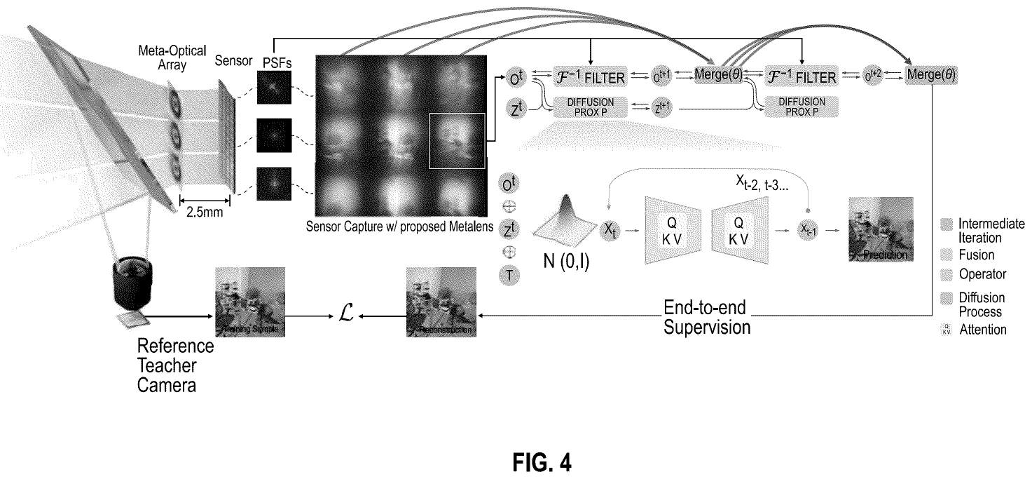

Disclosed embodiments propose a diffusion-based prior Ω (Ho et al. 2020; Sohl-Dickstein et al. 2015) to handle an ambiguity in deconvolution: multiple clear latent images can be projected to the same measurement I. Diffusion provides a probabilistic approach to generate multiple samples, from which disclosed embodiments can select the most suitable one. FIG. 4 illustrates the proposed prior model.

FIG. 4 illustrates an overview of probabilistic image reconstruction according to one embodiment of the present disclosure. Disclosed embodiments propose a deconvolution method that relies on the physics-based forward model (PSFs illustrated on the left) along with a learned probabilistic prior (diffusion model on the bottom right). The proposed method is an unrolled optimization method that alternates between inverse filtering steps using the calibrated PSFs, diffusion steps that sample from the natural image manifold with conditioning on the current iteration, and a merging step that combines the image estimates from all sub-apertures (green). The unrolled optimization method is trained in an end-to-end fashion with paired training samples captured with a co-axial reference camera (bottom and left), as described herein.

Disclosed embodiments first devise the forward process of diffusion by adding noise and learning to recover the clean image. Disclosed embodiments denote the disclosed input x₀ as I^{gt}, and the disclosed condition c is defined as

$$c = Igt ⊕ S ⊕ zt ⊕ μ t ⊕ γ ( T ) , \qquad ( 20 )$$

where Igt is the ground truth latent image, S is the sensor measurement, zt is the auxiliary image coupling term defined in Eq. (15), μt is an update weight defined in Eq. (16), and γ(T) is a positional encoding of T where T∈(1, 1000) is the timestep randomly sampled for each training iteration of the diffusion model. Note that the subscript t in zt and μt refers to the HQS iteration from Eq. (17), separate from T which refers to the diffusion timestep.

Here, ⊗ is the concatenation symbol, as disclosed embodiments condition the inputs by concatenating them along the channel dimension and employ self-attention (Vaswani et al. 2017) to learn corresponding features.

To train the disclosed diffusion model, in each iteration disclosed embodiments add Gaussian noise to the I^{gt} of x₀ proportional to T to obtain xₜ. Specifically, disclosed embodiments train the model Ω to recover O^{gt} from xₜ. Similar to (Chou et al. 2022), disclosed embodiments recover O^{gt} rather than the added noise. To tackle moderate misalignment in the disclosed dataset, disclosed embodiments employ a Contextual Bilateral loss (CoBi) which is robust to misalignment of image pairs in both RGB and VGG-19 feature space (Zhang et al. 2019). the disclosed overall training objective is

$${L}_{diff} = {{L}_{CoBi} ( Ω ( {x}_{t} ) , {I}^{gt} )}_{RGB} + λ {{L}_{CoBi} ( Ω ( {x}_{t} ) , {I}^{gt} )}_{VGG} , \qquad ( 21 )$$

where λ is empirically selected via experimentation. The architecture of the disclosed diffusion model is a UNet (Ronneberger et al. 2015) following (Ho et al. 2020).

During test time, the disclosed diffusion model performs generation iteratively. In the vanilla DDPM (Ho et al. 2020), generation is performed as follows

$${z}^{′} = ( f ∘ … ∘ f ) ( {z}_{T} , T ) , f ( {x}_{t} , f ) = Ω ( {x}_{t} ) + {σ}_{t} ϵ , \qquad ( 22 )$$

where z_{T}˜N(0, I), σₜ is the fixed standard deviation at the given timestep, and ϵ˜N(0, I). However, this results in long sampling times. Instead, disclosed embodiments follow DDIM (Song et al. 2021) and adopt a non-Markovian diffusion process to reduce the number of sampling steps. Furthermore, disclosed embodiments use the “consistency” property that allows disclosed embodiments to manipulate the initial latent variable to guide the generated output. As a result, ƒ(xₜ, t) from Eq. (22) can be defined as

$$f ( {x}_{t} , t ) = \sqrt{{α}_{t - 1}} ( \frac{{x}_{t} - \sqrt{1 - {α}_{t}} Ω ( {x}_{t} )}{\sqrt{{α}_{t}}} ) + \sqrt{1 - {α}_{t - 1} - {σ}_{t}^{2}} \cdot Ω ( {x}_{t} ) + {σ}_{t} ϵ . \qquad ( 23 )$$

In practice, disclosed embodiments find generation timesteps of 20 sufficient for the disclosed experiments.

### Learned Array Deconvolution and Blending

The nanophotonic array lens measures an array of images, each with a different FoV, which disclosed embodiments deconvolve and merge together to form a wider FoV image. Disclosed embodiments employ the probabilistic image recovery approach described in Sec. 4.1 for deconvolving the array of images. Specifically, the individual latent images in the array are recovered by solving

$${I}_{\tilde{m , n}} = {arg min}_{\{ {I}_{m , n} \}} \frac{1}{2} {‖ {I}_{m , n} ⊗ {k}_{m , n} - {S}_{m , n} ‖}^{2} + ρΓ ( {I}_{m , n} ) , \qquad ( 24 )$$

where (m, n) corresponds to the sub-image in the m-th row and n-th column of the sensor array measurement. For solving this, disclosed embodiments first acquire real PSF measurements k_{m,n} for each element of the metalens array. An sensor measurements S_{m,n} are acquired as a dataset of images captured in various indoor and outdoor environments, as described next in Sec. 5, to allow for learning the probabilistic prior Γ over natural images.

The recovered array of latent images are finally blended together into a wider FoV super-resolved image to approximately match the sensor resolution. Given an (m, n) array of input images {Im,n} where (m, n)={0, 1, 2, . . . }, the disclosed goal is to produce a wide-range im-age I_{B}, which is obtained by appropriately correcting, stitching and blending the individual sub-images recovered from the metalens array measurement. To this end, disclosed embodiments employ a modified UNet blending network to learn the blending function ƒB which takes a blended homography-transformed stack of concatenated mn sub-images (see Sec. 5.1) and a coarse alpha-blended wide-range image I_{B}^{α} as input, and produces the correctly blended image as the output,

$${I}_{B} = {f}_{B} ( \{ {I}_{m , n} \} , {I}_{B}^{α} ) . \qquad ( 25 )$$

To learn the function ƒ_{B}, the blending network is supervised over groundtruth images acquired using an aberration corrected com-pound optic camera, see Sec. 5.2. The loss function L used is a combination of pixel-wise error and perceptual loss during the training

$$L = {L}_{1} + {L}_{LPIPS} , \qquad ( 26 )$$

to allow for accurate reproduction of color and features while also accounting for any misalignments in the in-the-wild captured data pairs as well as systemic errors in the prototype data acquisition setup. Moreover, supervising the disclosed blending network on the full sensor resolution groundtruth image measurements also allows for recovering a high-fidelity latent image from the m×n low resolution sub-images from the metalens array camera.

### Implementation

The proposed deconvolution framework and the learned blending network are implemented in PyTorch. The training for the over-all deconvolution approach is done iteratively and progressively to sample over a large plausible manifold of latent images from the sensor measurements. For all the training purposes, disclosed embodiments use a dataset with groundtruth images of 800×800 resolution and 9 patches of 420×420 sub-images measured from individual metalenses in the nanophotonic array. Training was performed using the paired groundtruth and metalens array measurements acquired using the experimental paired-camera setup, see Sec. 5. During the deconvolution step, an initial filtered image obtained according to Eq. (18) is passed through a probabilistic diffusion-prior model that progressively corrupts the filtered image with additive noise and recovers the latent image by sampling over the manifold of prob-ability distribution of image priors. To preserve color fidelity, disclosed embodiments normalize the image to range (0, 1). Disclosed embodiments use the ADAM optimizer with β₁=0.5 and β₂=0.999, and λ=1.2 for the training objective in Eq. (21).

### Experimental Prototype and Datasets

This section describes the dataset and camera prototype disclosed embodiments use to train the proposed reconstruction network. The training dataset consists of simulated data and captured paired image data. Disclosed embodiments first describe the synthetic dataset, then the capture setup and the acquisition of the proposed paired dataset. Finally, disclosed embodiments describe the fabrication process of the proposed nano-optical array.

### Synthetic Dataset

Training the probabilistic image recovery network described in Sec. 4 requires a large and diverse set of paired data, which is challenging to acquire in-the-wild. Therefore, disclosed embodiments simulate the nanophotonic array camera with the corresponding metalens design parameters, to generate a large synthetic dataset of paired on-sensor and groundtruth measurements. Disclosed embodiments use this large synthetic dataset for training alongside a smaller real-world dataset for fine-tuning. Each metalens in the array camera has a focal length of 2 mm and covers an FoV of 60° for a broadband illumination, with the center-to-center distance between the metalenses on-chip being 2.42 mm. Due to the circular aperture of each metaoptic, the sensor measurements exhibit vignetting at higher eccentricities.

For a given groundtruth image, disclosed embodiments first crop 9 images that correspond to the final 3×3 metalens array camera measurement, with each metalens measurement corresponding to 60° FoV and the groundtruth image corresponding to a total of 90° FoV. Each of the 9 images are subjected to vignetting where disclosed embodiments model the vignetting mask as a fourth-order Butterworth filter with linear intensity fall-off, given by

$$V = {( 1 + {( \frac{{‖ w ‖}^{2}}{{f}_{c}^{2}} )}^{4} )}^{- 1} \qquad ( 27 )$$

where ∥⋅∥² denotes the squared magnitude, w is the spatial frequency and ƒc is the cutoff frequency of the filter. All parameters are matched to the experimental setting. Note that disclosed embodiments apply this filter on each individual metalens measurement only as an intensity mask to the sensor image and the disclosed cutoff frequency corresponded to 45° of the metalens FoV. The vignetted images are convolved with the simulated PSFs on the sensor as described in Eq. (7) and further corrupted by simulated sensor noise described in Eq. (8). The simulated individual metalens measurements are then resized and arranged in a 3×3 array to simulate the nanophotonic sensor capture. To this end, disclosed embodiments first compute homographies between the 9 local image patches as measured by the real nanophotonic array camera and the ground truth compound optic camera, which is described next in Sec 5.2, to transform the ground truth image to map that of the sensor capture. Disclosed embodiments then utilize these homography transforms to project each of the 9 simulated metalens measurements onto the appropriate local patch on the sensor

$${\hat{P}}_{mn}^{gt} \to {H}_{mn} {p}_{mn}^{s} , \qquad ( 28 )$$

where P\hat{ }ₘₙ^{gt} denotes the coordinates in the ground truth image corresponding to the FoV as captured by the (m, n)-th metalens in the array camera, pmn denotes the sensor coordinate corresponding to the (m, n)-th metalens measurement and Hmn denotes the corresponding homography. The final sensor measurement is simulated as

$${S}_{mn} = {H}_{mn}^{- 1} I * V ) ⊗ {k}_{mn} + η sensor , \qquad ( 29 )$$

$$S = {\sum }_{m , n} {S}_{mn} s . t . ( m , n ) ∈ \{ 0 , 1 , 2 \} \text{:} m + n \leq 2. \qquad ( 30 )$$

where Sₘₙ denotes the (m, n)-th array measurement on the sensor, S being the final sensor measurement, Hₘₙ⁻¹ and kₘₙ being the corresponding inverse homography and PSF, respectively. The sensor noise added is as determined by the parameters Cₛₑₙₛₒᵣ={σ_{g}, aₚ} which disclosed embodiments determine to be θ_{g}=1×10⁻⁵ and aₚ=4×10⁻⁵ using the calibration method as described in Foi et al. (Foi et al. 2008).

To generate the full synthetic dataset, disclosed embodiments randomly sample 10,000 images from a combination of ImageNet (Deng et al. 2009) and MIT 5K (Bychkovsky et al. 2011) datasets for groundtruth images. The disclosed training dataset contains approximately 8000 images and the validation and test data splits contain 1000 each. The networks trained on the disclosed synthetic dataset are then further finetuned on in-the-wild real data which disclosed embodiments describe in the following.

### Experimental Setup and Dataset

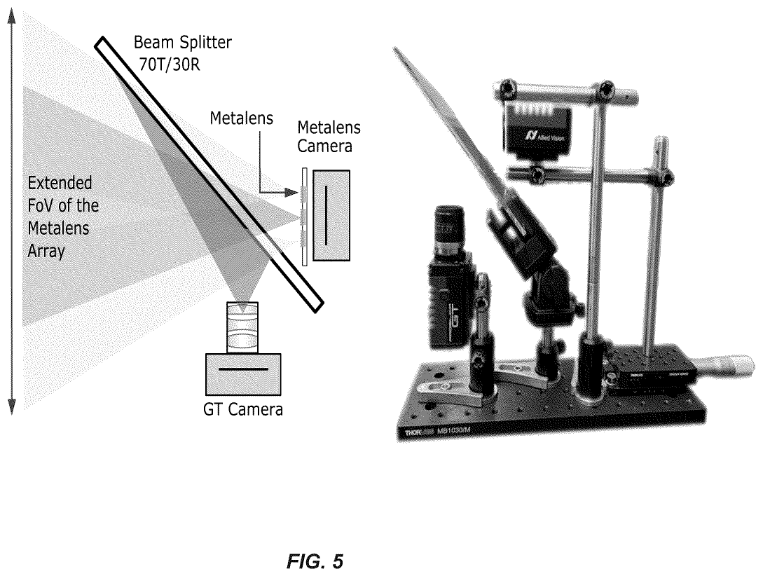

To acquire the paired experimental data, disclosed embodiments developed a hardware setup shown in FIG. 5, which can simultaneously capture real-world scenes from the metalens array camera and a reference camera such as one having a conventional off-the-shelf lens. In the exemplary capture setup of FIG. 5, disclosed embodiments employ a plate beam splitter, which splits world light into two optical paths by 70% transmission and 30% reflection. The positions of the plate beam splitter and the two cameras are precisely aligned such that the optical centers and the optical axes of the two cameras are as close as possible. The two cameras are synchronized to capture scenes with the same timestamps.

Accordingly, to generate the paired data acquisition, the capture setup of one disclosed embodiment, employs a plate beam splitter, which splits world light into two optical paths by 70% trans-mission and 30% reflection such that the setup can simultaneously capture real-world scenes with one camera in the transmission path that employs the designed metalens array and another camera in the reflection path that employs a conventional off-the-shelf lens (GT camera). The two cameras are aligned and calibrated to map one to the other captures, as described herein.

Disclosed embodiments employ an Allied Vision GT1930 C sensor of 5.86 micron pixel pitch and 1936×1216 resolution for the metalens array camera such that the effective FoV (Field-of-View) from all the metalens elements in the array can be captured in the same frame. The same sensor is used for the reference camera which has a 3.5 mm focal length, wide FoV lens from Edmund Optics such that disclosed embodiments can achieve a FoV larger than the full FoV of the metalens array camera in the “ground truth” captures. A third Allied Vision GT1290C camera with 3.75 micron pixel pitch and 1280×960 resolution is used for mounting the metalens proposed by Tseng et al. (2021a), which disclosed embodiments compare against in Section 6. Disclosed embodiments use Precision Time Protocol (PTP) to synchronize all the cameras such that the captures are taken at the same timestamps with sub-millisecond precision. After disclosed embodiments align the sensor parallel to the disclosed fabricated metalens array, disclosed embodiments perform fine alignment between the sensor and the metalens array with a 3D translation stage, where the sensor is mounted to. When the alignment is completed, the sensor captures the effective FoV of all the metalens array elements and the images are focused on the sensor plane. See Supplemental Material for details.

After the alignment, disclosed embodiments conduct PSF measurements of the individual metalens elements in the array, which are used in the model-based part of the image reconstruction method. The light sources that disclosed embodiments use are red, green, and blue fiber-coupled LEDs from Thorlabs (M455F3, M530F2, and M660FP1). The fiber has a core size of 800 microns diameter and the fiber tip is placed 340 mm away from the metalens array such that it can be approximated as a point source with an angular resolution that is the same as the angular resolution of one pixel in the captured metalens images (arc-min). The PSFs of all the metalens elements are captured in the same frame. By turning on and off each individual color LED, disclosed embodiments can acquire the PSFs of different colors. When alternating between colors, disclosed embodiments change the input of the fiber without introducing mechanical shifts to the output of the fiber such that the position of the point light source is fixed.

Next, disclosed embodiments align the optical center and the optical axis of the central element from the metalens array camera to those of the reference camera. Disclosed embodiments use collimated laser and pinhole apertures to make sure the beam splitter is positioned at a 45° tilting angle. Then, disclosed embodiments set up the position of the metalens array camera and adjust the laser beam height such that the transmission path is incident on the center metalens element. The center of the reference camera is positioned in the reflection beam path and the distance between the beam splitter and the reference camera sensor is adjusted to the same as that between the beam splitter and the metalens array camera. Disclosed embodiments achieve accurate alignment by observing a reference target with both cameras simultaneously until the two cameras are aligned.

After all the alignment is completed, the setup is mounted on a tripod with rollers, as shown in FIG. 5, such that it can be moved around indoors and outdoors for acquiring a diverse dataset. In the capture process, the exposure time is chosen so that the photos from the two cameras are bright but unsaturated, and the frame rate is chosen to make sure that there is a sufficient difference in the scenes for a few consecutive frames. When disclosed embodiments change the scenes, the exposure time of the two cameras is adjusted proportionally such that the image brightness is adapted to different scenes while the light throughput ratio between the two cameras is unchanged. The exposure time of the metalens array camera ranges between 50 ms to 150 ms and the exposure time of the reference camera is 1.2× that of the metalens camera.

Per-pixel Mapping between Two Cameras. To find the per-pixel mapping between the reference camera and the metalens array camera, disclosed embodiments have the two cameras capture red, green and blue checker-board patterns shown on a large LCD screen and then calibrate the distortion coefficients of the two cameras per color channel. After the image acquisition, disclosed embodiments perform image rectification for the captures from both cameras. Then, to account for the difference in camera FOV and the difference in viewing perspectives between each metalens array element and the reference camera, disclosed embodiments perform homography-based alignment to map the reference camera captures to the captures from all the metalens array elements.

### Fabrication of the Meta-Optic

The optimized meta-optic design described in Sec. 3 was fabricated in a 700 nm SiN thin film on fused silica substrate. First a SiN thin film was deposited on a fused silica wafer via plasma-enhanced chemical vapor deposition. The meta-optic array was then written on a single chip via electron beam lithography (JEOL-JBX6300FS, 100 kV) using a resist layer (ZEP-520A) and discharging polymer layer (DisCharge H2O). After development, a hard mask of alumina (65 nm) was evaporated, and subsequently lift-off overnight in NMP at 110° C. After a brief plasma clean to remove organic residues, disclosed embodiments used inductively-coupled reactive ion etching (Oxford Instruments, PlasmaLab100) with a fluorine based etch chemistry to transfer the meta-optic layout from the hard mask into the underneath SiN thin film. Finally, disclosed embodiments created apertures for the meta-optics to exclude un-modulated light that passed through non-patterned regions. These apertures were created through optical direct write lithography (Heidelberg-DWL66) and subsequent deposition of a 150 nm thick gold film. The disclosed array has a total size of ˜7 mm² with elements 1 mm in diameter and F #2.4. Disclosed embodiments avoid optical baffles in the disclosed prototype and, to ensure no overlap, instead space out the lenslets over the wafer with ˜15% of the area being used as apertures. However, note that disclosed embodiments do not use the peripheral regions of each sublens; hence, disclosed embodiments use non-continuous regions of pixels totaling ˜40% of the full sensor area. In the future, integrating optical baffles to separate array elements may eliminate the need for separation. However, fabricating and aligning baffles is not a simple feat and disclosed embodiments prototype the disclosed camera without them. Please refer to the Supplemental Material for additional details.

### Assessment

### Synthetic Evaluation

Before validating the proposed method on experimental captures, disclosed embodiments separately evaluate the probabilistic deconvolution method and the proposed thin camera in simulation. To this end, disclosed embodiments use unseen test set (consisting of 1000 images) from the disclosed synthetic dataset described in Sec. 5.1 to assess the method with paired ground truth data.

Assessment of Probabilistic Deconvolution. Existing non-blind de-convolution methods do not operate on several sub-aperture images that are combined together to form a final image. To assess the proposed probabilistic deconvolution method in isolation, and allow for a fair comparison, instead of considering all nine sub-apertures of the proposed meta-optic, disclosed embodiments consider only the central portion. Doing so allows disclosed embodiments to compare the proposed reconstruction method with a single PSF and image—the setting that existing non-blind deconvolution methods are addressing. For this experiment, disclosed embodiments drop the blending operator from the proposed method described in Sec. 4 and train the remainder of the method as described next.

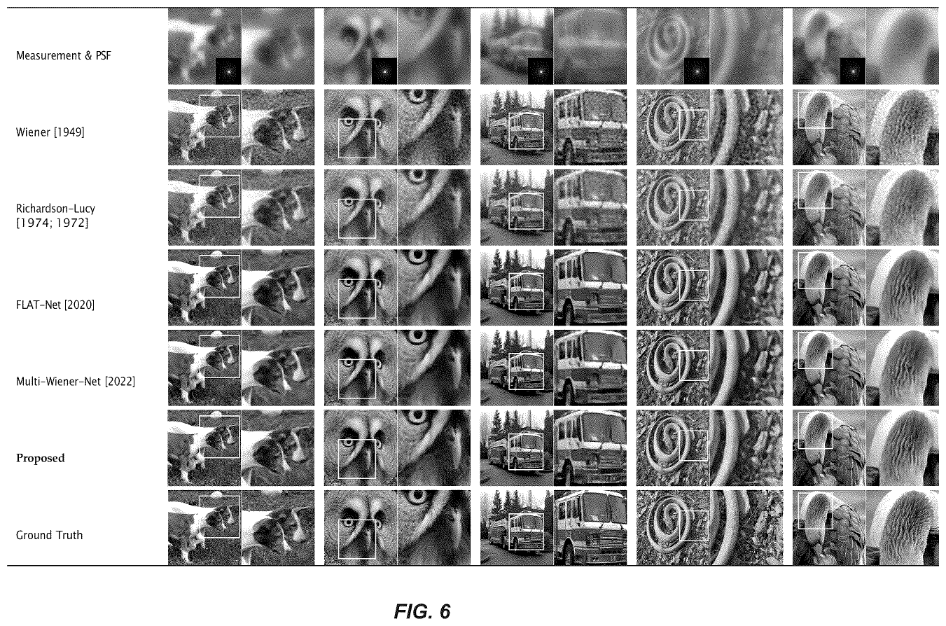

FIG. 6 illustrates a synthetic qualitative assessment of diffusion-based deconvolution according to one embodiment of the present disclosure. Results on unseen validation set. The two conventional deconvolution approaches (Wiener (Wiener et al. 1949) and Richardson-Lucy (Richardson 1972)) suffer from apparent reconstruction noise. The predictions from Flatnet (Khan et al. 2020) and Multi-Wiener-Net (Yanny et al. 2022) are overly smooth with high-frequency details missing. The proposed probabilistic reconstruction method is capable of recovering fine details, such as the grass (left), feathers (center left), or grill (center) without severe reconstruction noise.

Disclosed embodiments report qualitative and quantitative results in Table 2 and FIG. 6 which both validate the proposed reconstruction method. Specifically, disclosed embodiments compare the disclosed method to existing conventional and learned non-blind deconvolution methods, that is Wiener inverse filtering (1949) and Richardson Lucy iterations (1974; 1972) as traditional methods, and the FLAT-Net (Zhou et al. 2020) and Multi-Wiener Net (Yanny et al. 2022) as recent learning-based approaches. Disclosed embodiments retrain the two learning-based approaches on the disclosed synthetic data for a fair comparison. Table 2 confirms that the proposed method outperforms all compared methods in all metrics, that is SSIM, PSNR, and LPIPS (Zhang et al. 2018).

TABLE 2
Qualitative Assessment of Probabilistic Non-blind Deconvolution.

| | | | | Multi- | |
|---|---|---|---|---|---|
| | | Richardson- | Flatnet | Wiener- | |
| | Wiener | Lucy | ²[2020] | Net [2022] | Proposed |
| SSIM ↑ | 0.452 | 0.486 | 0.679 | 0.648 | 0.754 |
| PSNR [dB] ↑ | 19.38 | 19.97 | 24.63 | 22.90 | 25.80 |
| 1-LPIPS ↑ | 0.360 | 0.495 | 0.672 | 0.569 | 0.773 |

To evaluate the proposed reconstruction method, disclosed embodiments simulate aberrated and noisy images of the central lens in the disclosed optical design, see Sec. 5.1. Disclosed embodiments evaluate all methods on the disclosed synthetic validation set and find that the pro-posed method outperforms all baselines in SSIM, PSNR, and LPIPS (2018).

Although all learned methods are trained on the same data, the proposed method improves on the existing learned baseline methods by a margin of more than 1 dB in PSNR. The qualitative results reported in FIG. 6 confirm this trend. While the learned approaches, FLAT-Net and Multi-Wiener-Net are robust to noise and function in presence of large blur kernels such as the one simulated in this experiment—in contrast to the conventional methods—their predictions tend to be oversmoothed. The proposed probabilistic prior is capable of recovering fine details, such as the swan feather structure (right), headlights of the fire truck (center) and details in grass and face of the dogs (left).

Validation of Thin Imager Design. Next, disclosed embodiments validate the proposed thin camera design in simulation. Disclosed embodiments again rely on the unseen test set from the disclosed synthetic dataset described in Sec. 5.1 to evaluate the method with ground truth data available. Disclosed embodiments now consider all nine sub-apertures on the sensor that require employing the blending operator disclosed embodiments dropped for the experiments described above.

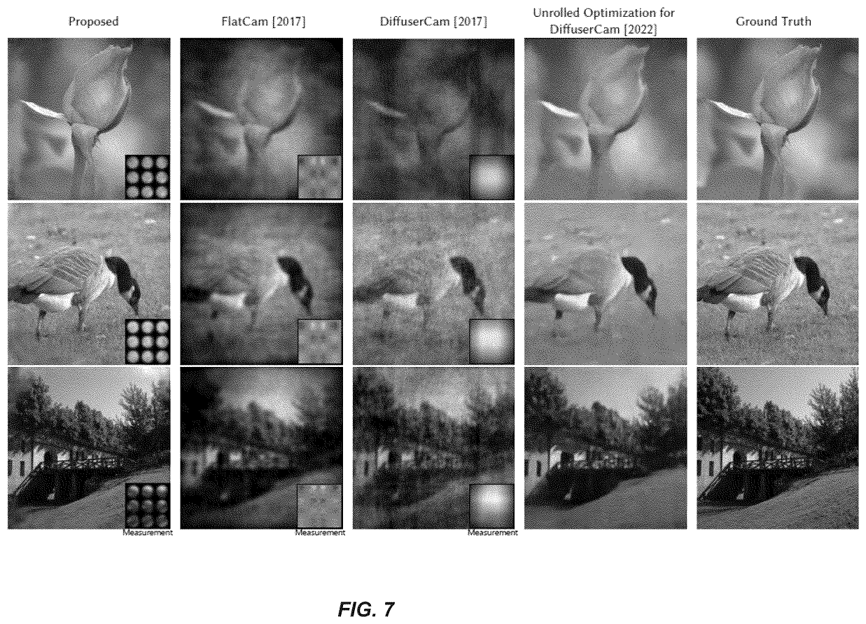

FIG. 7 includes simulated sensor measurements as insets for a few scenes. Results on unseen validation set. Alternative thin sensing approaches in FlatCam (2017) and DiffuserCam (Kuo et al. 2017) allow for capturing rays from a large cone of angles, however, they mix spatial and color information in PSFs with support of the entire sensor, see insets. This makes the recovery of high-frequency details challenging, even for learning-based methods (Kingshott et al. 2022). The proposed camera design captures high-quality information across almost the entire field of view.

The qualitative and quantitative evaluations in Table 3 and FIG. 7 validate the proposed thin camera design.

TABLE 3
Qualitative Assessment of Thin Camera Design.

| | FlatCam | FlatNet | DiffuserCam | Kingshott | Proposed w/ | |
|---|---|---|---|---|---|---|
| | (2017) | (2020) | (2017) | et al. (2022) | Tikhonov | Proposed |
| SSIM ↑ | 0.544 | 0.533 | 0.479 | 0.594 | 0.731 | 0.892 |
| PSNR (dB) ↑ | 19.25 | 20.61 | 16.42 | 21.24 | 25.47 | 32.66 |
| 1-LPIPS ↑ | 0.292 | 0.426 | 0.255 | 0.348 | 0.71 | 0.803 |

To evaluate the nanophotonic array camera design proposed in this work, disclosed embodiments simulate aberrated and noisy images for the disclosed 3×3 array following Sec. 5.1, and recover images with the proposed probabilistic reconstruction method. Disclosed embodiments assess the image quality compared to FlatCam (Asif et al. 2017) and Diffuser-Cam (Antipa et al. 2018) as alternative thin camera design approaches. Disclosed embodiments evaluate all methods on the disclosed unseen synthetic validation set and find that the proposed design compares favorably in SSIM, PSNR, and LPIPS (2018).

Here, disclosed embodiments compare the proposed thin imager to successful imaging methods with a flat form factor: the FlatCam (2017) design, which employs an amplitude mask placed in the sensor cover glass region instead of a compound lens, and DiffuserCam (2017) relying on a caustic PSF resulting from a diffuser placed above the coverglass. In addition to evaluating the image formation and reconstruction methods pro-posed in the original works, disclosed embodiments also evaluate recent learning-based reconstruction methods, including FlatNet (Khan et al. 2020) which is capable of learning from FlatCam observations, and the unrolled optimization method with neural network prior from Kingshott et al. (2022) that recovers images from diffuser measurements. Disclosed embodiments retrain the learning-based approaches on the disclosed synthetic data for a fair comparison. The proposed thin imager improves on all alternative designs both quantitatively and qualitatively. While FlatCam and DiffuserCam sensing allow the capture of rays from a large cone of angles, the spatial and color information is entangled in PSFs with support of the entire sensor, making the recovery of high-frequency content challenging independent of the FoV. As such, all examples in FIG. 7 confirm the trend from the quantitative Table 3—the proposed metasurface array imager is able to image fine details across almost the entire field of view. The flower (top) and draw bridge (bottom) are reconstructed with high fidelity across the entire image. Only in the peripheral corners of the image, the proposed method is not capable of recovering details as image information is missing, which is filled in by the blending network.

The proposed camera design benefits from both the optical de-sign and the probabilistic prior. To analyze the contribution of these two components, disclosed embodiments conduct an ablation experiment by replacing the diffusion prior with a non-learned prior. Because spatial priors, including Total Variation (TV) regularization and neural network-based learned priors, both can “hallucinate” frequency content missing in the measurements (e.g., high-frequency edges in the case of TV), disclosed embodiments compare the disclosed approach to Tikhonov regularization (Golub et al. 1999) as a traditional per-pixel prior. Disclosed embodiments observed an average PSNR of 25.5 dB, which still outperforms all alternative flat camera designs by more than 4 dB. The proposed diffusion prior further improves this by 7.2 dB with the same input data used by all methods. These additional evaluations further validate both the optical design and effectiveness of the diffusion prior.

### MTF and FoV Analysis

Next, disclosed embodiments analyze the optical performance of the proposed nanophotonic array lens via its theoretical modulation transfer function (MTF), i.e., the ability of the array lens to transfer contrast at a given spatial frequency (resolution) from the object to the imaging sensor. As discussed in Sec. 3, the disclosed lens is optimized for broadband illumination across the visible spectrum and to span an effective FoV of 70° for a 3×3 and an FoV of 80° for a 5×5 metalens array, respectively, with each individual lens in the array capturing a total FoV of 45°. Disclosed embodiments calculate the MTF of the disclosed array designs and compare to the recent design from Tseng et al. (2021a), which is reported to achieve a total FoV of 40°.

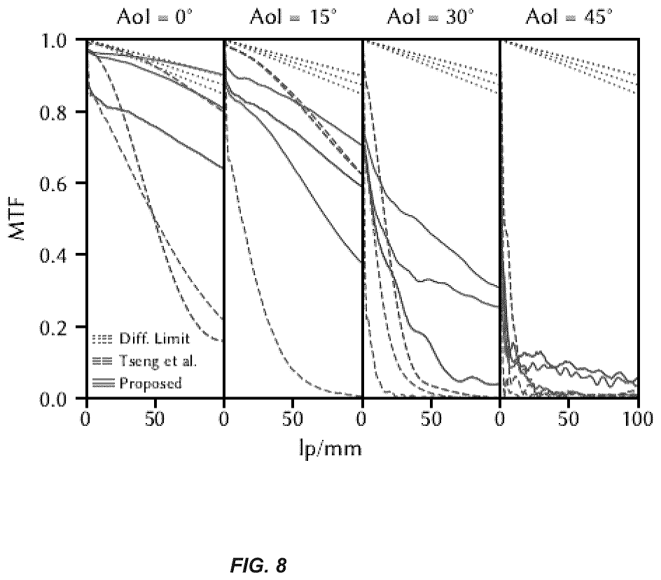

FIG. 8 is a graph showing the calculated MTF for various angle of incidence (AoI) for array MO with varying wedge phase profile. Thick solid lines correspond to the diffraction limit. Dashed lines correspond to calculated MTF curves for Tseng et al. (2021a). Full thin lines correspond to the MO, presented in the disclosed work, with wedge phase as specified in the title. The x-axes represent line pairs per mm, within the specific resolution range for the used sensor, with a pixel size of 5.7 μm.

The analysis in FIG. 8 validates that the proposed metalens exhibits a significantly improved MTF under different angle of incidence (AoI) compared to the existing designs, approaching the efficiency of diffraction limit for normal incidence of light (shown in black in FIG. 8) and achieving higher MTF values for larger incidence angles. Importantly, even at large AoI, the MTF is sufficiently large to enable reconstruction through a computational backend. This allows for high-fidelity signal measurements and robust full-color deconvolution. With increasing angles of incident light, although the MTF performance drops, the disclosed metalens compares favorably to the design from Tseng et al. The MTF performance of the disclosed lens is also reflected in the raw sensor measurements.

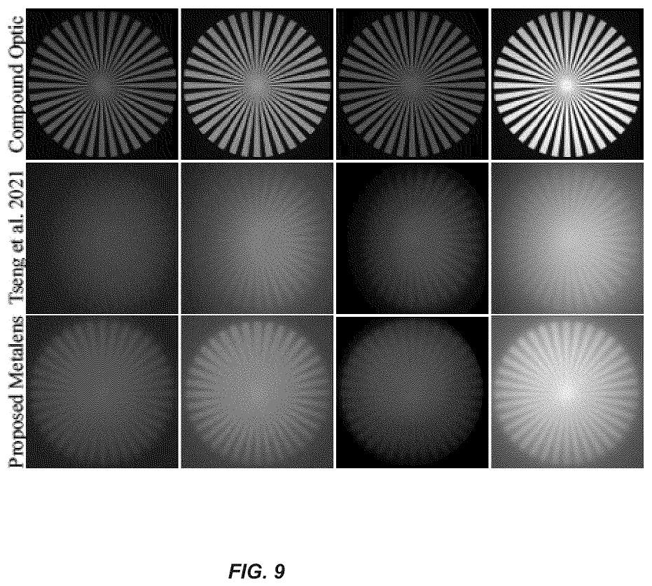

FIG. 9 reports the raw sensor measurement using a compound optic, the metalens by Tseng et al. (2021a), and the measurement from the disclosed proposed metalens design. Even without reconstruction, the disclosed metalens design significantly reduces scattering compared to the previous state-of-the-art design proposed by Tseng et al. (2021a) across all wavelengths, thereby allowing for broadband imaging in-the-wild. When combined with probablistic deconvolution method, the proposed nanophotonic array camera robustly recovers the latent image. Although Tseng et al. (2021a) designed their metalens specificially for trichromatic red, green and blue wavelengths, the sensor measurement of the calibration Siemens star pattern show significant scattering resulting in loss of image quality. Note that the MTF considerations above are based on the direct sensor measurement without the algorithmic framework employed for latent image recovery. However, the effective MTF which also considers the image recovery algorithm (Fontbonne et al. 2022) which disclosed embodiments review later in the disclosed experimental results.

### Experimental Assessment

In the following, disclosed embodiments validate the proposed camera design with experimental reconstructions from captures acquired with the prototype system from Sec. 5.2. To this end, disclosed embodiments aim to capture scenes that feature high-contrast detail, depth discontinuities, and color spanning a large gamut. To test the camera system in in-the-wild environments, disclosed embodiments acquire scenes in typical broadband indoor and outdoor scenarios. As such, disclosed embodiments note that, to the best of knowledge, disclosed embodiments is the first demonstration of broadband nanophotonic imaging outside the lab.

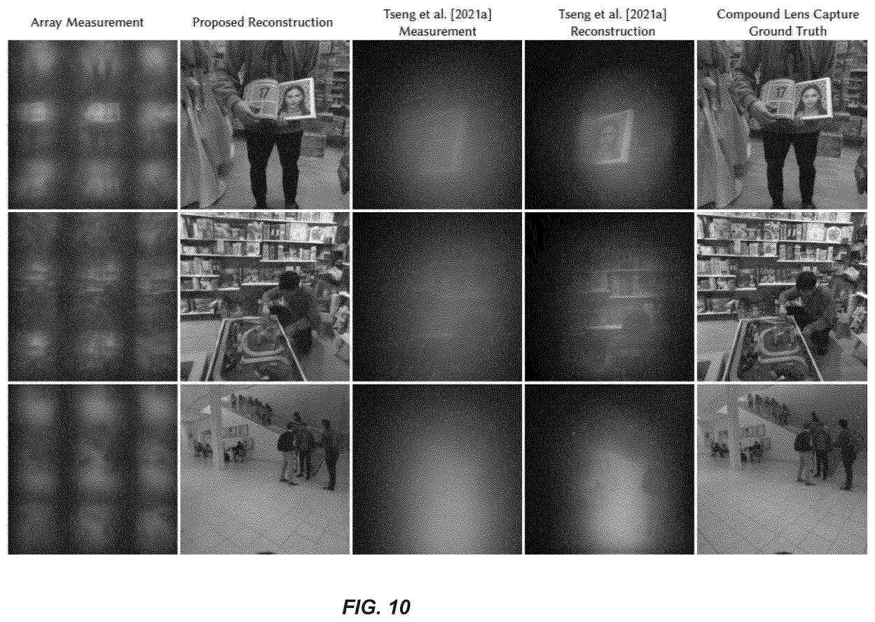

FIG. 10 illustrates experimental evaluation of the proposed thin nanophotonic camera on broadband indoor scenes according to one embodiment of the present disclosure. The proposed nanophotonic array optic with the probabilistic deconvolution method reconstructs the underlying latent image robustly in broadband lit environments. As a comparison, Tseng et al. (2021a) cannot recover the color and spatial details of the scenes well.

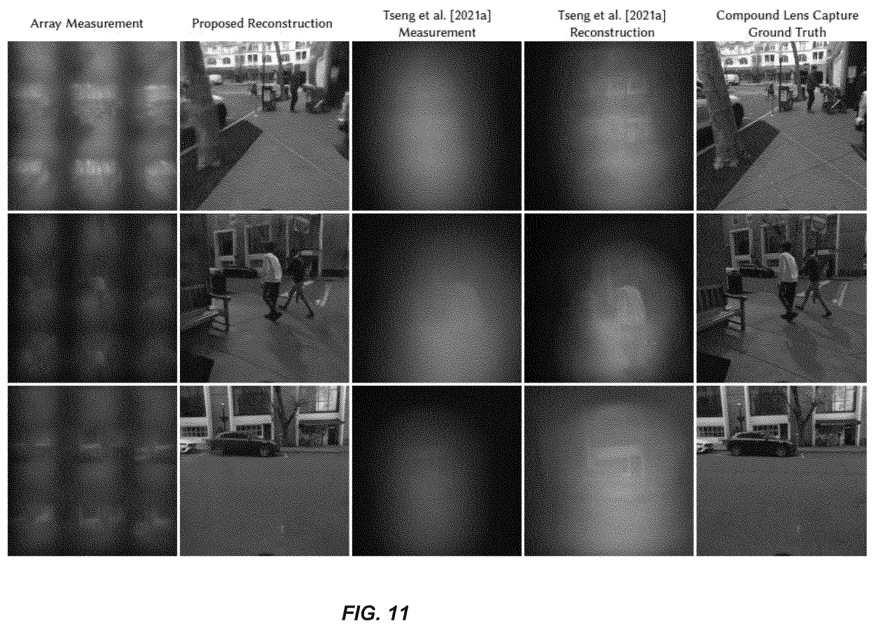

FIG. 11 illustrates experimental evaluation of the proposed thin nanophotonic camera on broadband outdoor scenes according to one embodiment of the present disclosure. The proposed nanophotonic array optic with the probabilistic deconvolution method reconstructs the underlying latent image robustly in broadband lit environments, outperforming Tseng et al. (2021a) significantly in outdoor scenes.

Accordingly, FIGS. 10 and 11 show images as captured by the previous state-of-the-art (Tseng et al. 2021a) and proposed thin-lens camera, and the corresponding reference images captured using a compound optical lens for a variety of indoor and outdoor scenes. The reconstructions from Tseng et al. were measured on a sensor of smaller size, see Sec 5.2, which disclosed embodiments do not resize here, unlike in the Teaser 1.3 The images recovered using the proposed nano-optic and reconstruction algorithm outperform existing approaches. The proposed thin camera is capable of imaging the scene adequately with accurate color reproduction. While the peripheral regions, reconstructed from elements with strong wedge phase elements, contain less spatial detail than the center region, they still recover detail over the entire design field of view. The center region of the recovered images has relatively high image quality and captures fine detail present in the reference images. The reconstructed images suffer from no apparent chromatic aberrations, which have been an open problem in the design of broadband metasurface optics.

Comparison to Neural Nano-Optics (Tseng et al. 2021a). Disclosed embodiments compare the proposed design experimentally to the broadband design from Tseng et al. (2021a). While their lens design is the most successful existing broadband metalens design, it is designed for a fixed set of three wavelength bands. As Tseng et al. (Tseng et al. 2021a) report, their design performs well for the narrow selective spectrum of an OLED display that is imaged with an optical relay system. Disclosed embodiments confirm this experimentally in the Supplemental Material. For the full broadband scenarios that disclosed embodiments tackle in the disclosed work, their design comes with severe scattering that is not apparent when imaging a screen with black surrounding region, as shown in FIGS. 10 and 11. For the experimental scenes captured in the disclosed work, the proposed method significantly outperforms this existing design in image quality and size of the field of view. This experiment validates the proposed broadband design methodology and the array sensing approach disclosed embodiments investigate in this work.

Experimental Validation of Denser 5×5 Design. In addition to the 3×3 array investigated above, disclosed embodiments have also fabricated an additional 5×5 array with an additional peripheral set of nanophotonic lenslets to cover a larger field of view of 120°. Unfortunately, the sensors available to disclosed embodiments (with sufficient lead time) were slightly too small to capture the entire array, and spacing the elements closer would have required baffles and the removal of the coverglass on the sensor. (The epoxy-glued cover glasses on commodity mass-market sensor packages cannot be removed without specialized tools or destroying the sensor.)

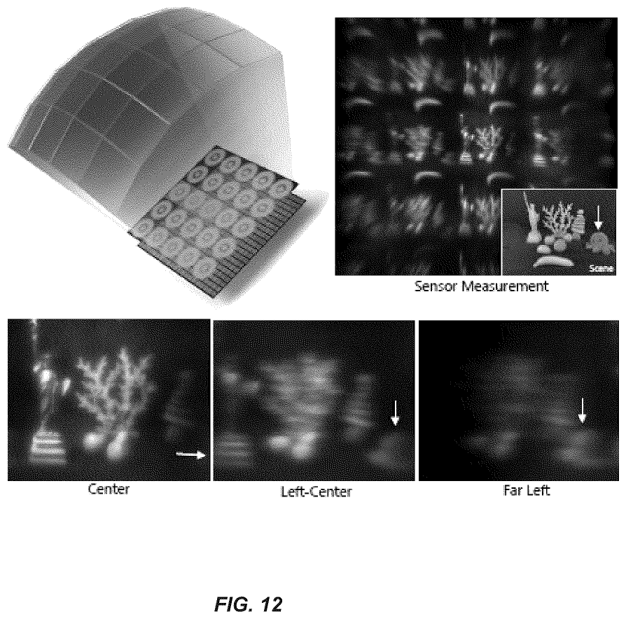

FIG. 12 illustrates an experimental assessment of 5×5 prototype lens according to one embodiment of the present disclosure. Although the fabricated array does slightly exceed the available sensor area, as discussed herein, the capture of the horizontal set of elements (indicated in orange) illustrates that neighboring elements with increasing wedge angles capture successively oblique field angles. Moving towards the array periphery, the red plush toy (indicated with white arrow) is entering (center-left) and moving progressively towards the center of the field of view of each individual lens.

As shown, FIG. 12 reports the measurement of a still life scene captured under broadband quartz light without image reconstruction. Although the full capture of the array is cropped due to the available sensor size, disclosed embodiments can observe the increasing field of view from the center element to the periphery. Validating the proposed design, as indicated in the figure, the red plush toy, completely outside the field of view of the center element, enters the field of view of the middle, and moves to the center in the left element.

### CONCLUSION

Disclosed embodiments investigate a flat camera that employs a novel array of nanophotonic optics that are optimized for broadband spectrum and collaboratively capture a larger field of view than a single element. The proposed nanophotonic array is embedded on a metasurface that sits on top of the sensor cover glass making the proposed imager thin and manufacturable with a single-element optical system. Although disclosed embodiments devise a differentiable lens design method for the proposed array metasurface sensor-allowing disclosed embodiments to suppress aberrations across the full visible spectrum that exist in today's heuristic and optimized metasurface optics—the proposed design is not without aberrations. Disclosed embodiments propose a probabilistic image reconstruction method that allows disclosed embodiments to recover images in presence of scene-dependent aberrations in broadband—an open problem using metasurface optics. Disclosed embodiments validate the proposed nanophotonic array camera design experimentally and in simulation, confirming the effectiveness not only of the optical design, compared against existing broadband metasurface optics, but also the deconvolution method, compared in isolation or against alternative thin camera designs. In the future, disclosed embodiments plan to explore integrating low-cost baffles and the co-design with sensor color-filter arrays into the proposed design which requires scale-able fabrication integrated into the sensor cover glass. Disclosed embodiments hope that the proposed camera can not only inspire novel designs, e.g., flexible sensor arrays, but also re-open an exciting design space computational photography community has explored in the past, that is light field arrays, color-multiplexed arrays, and task-specific array optics-all now directly on the sensor.

Having described the many embodiments of the present disclosure in detail, it will be apparent that modifications and variations are possible without departing from the scope of the invention defined in the appended claims. Furthermore, it should be appreciated that all examples in the present disclosure, while illustrating many embodiments of the invention, are provided as non-limiting examples and are, therefore, not to be taken as limiting the various aspects so illustrated.

### REFERENCES

The following references are referred to above and are incorporated herein by reference:
1. Francesco Aieta, Patrice Genevet, Mikhail A. Kats, Nanfang Yu, Romain Blanchard, Zeno Gaburro, and Federico Capasso. 2012. Aberration-Free Ultrathin Flat Lenses and Axicons at Telecom Wavelengths Based on Plasmonic Metasurfaces. Nano Letters 12, 9 (2012), 4932-4936. https://doi.org/10.1021/nl302516v
2. Francesco Aieta, Mikhail A. Kats, Patrice Genevet, and Federico Capasso. 2015. Multi-wavelength achromatic metasurfaces by dispersive phase compensation. Science 347 (2015), 1342-1345.
3. Nick Antipa, Grace Kuo, Reinhard Heckel, Ben Mildenhall, Emrah Bostan, Ren Ng, and Laura Waller. 2018. DiffuserCam: lensless single-exposure 3D imaging. Optica 5, 1 (2018), 1-9.
4. Amir Arbabi, Yu Horie, Mahmood Bagheri, and Andrei Faraon. 2015. Dielectric meta-surfaces for complete control of phase and polarization with subwavelength spatial resolution and high transmission. Nature Nanotechnology 10 (2015), 937-943.
5. Ehsan Arbabi, Amir Arbabi, Seyedeh Mahsa Kamali, Yu Horie, and Andrei Faraon. 2016. Multiwavelength polarization-insensitive lenses based on dielectric metasurfaces with meta-molecules. Optica 3, 6 (2016), 628-633.
6. Ehsan Arbabi, Amir Arbabi, Seyedeh Mahsa Kamali, Yu Horie, and Andrei Faraon. 2017. Controlling the sign of chromatic dispersion in diffractive optics with dielectric metasurfaces. Optica 4, 6 (June 2017), 625-632. https://doi.org/10.1364/OPTICA.4.000625
7. Ehsan Arbabi, Seyedeh Mahsa Kamali, Amir Arbabi, and Andrei Faraon. 2018. Full-Stokes imaging polarimetry using dielectric metasurfaces. Acs Photonics 5, 8 (2018), 3132-3140.
8. M. Salman Asif, Ali Ayremlou, Aswin C. Sankaranarayanan, Ashok Veeraraghavan, and Richard G. Baraniuk. 2017. FlatCam: Thin, Lensless Cameras Using Coded Aperture and Computation. IEEE Transactions on Computational Imaging 3, 3 (2017), 384-397.
9. Salman Asif, Ali Ayremlou, Aswin Sankaranarayanan, Ashok Veeraraghavan, and Richard G Baraniuk. 2016. Flatcam: Thin, lensless cameras using coded aperture and computation. IEEE Transactions on Computational Imaging 3, 3 (2016), 384-397.
10. Seung-Hwan Baek and Felix Heide. 2021. Polka Lines: Learning Structured Illumination and Reconstruction for Active Stereo. In Proceedings of the IEEE/CVF Conference on Computer Vision and Pattern Recognition (CVPR).
11. Seung-Hwan Baek, Hayato Ikoma, Daniel S Jeon, Yuqi Li, Wolfgang Heidrich, Gordon Wetzstein, and Min H Kim. 2021. Single-shot Hyperspectral-Depth Imaging with Learned Diffractive Optics. In Proceedings of the IEEE/CVF International Conference on Computer Vision. 2651-2660.
12. Mario Bertero, Patrizia Boccacci, and Christine De Mol. 2021. Introduction to inverse problems in imaging. CRC press.
13. Vivek Boominathan, Jesse K Adams, Jacob T Robinson, and Ashok Veeraraghavan. 2020. Phlatcam: Designed phase-mask based thin lensless camera. IEEE transactions on pattern analysis and machine intelligence 42, 7 (2020), 1618-1629.
14. Vladimir Bychkovsky, Sylvain Paris, Eric Chan, and Frédo Durand. 2011. Learning Photographic Global Tonal Adjustment with a Database of Input/Output Image Pairs. In The Twenty-Fourth IEEE Conference on Computer Vision and Pattern Recognition.
15. Philip Camayd-Muñoz, Conner Ballew, Gregory Roberts, and Andrei Faraon. 2020. Multifunctional volumetric meta-optics for color and polarization image sensors. Optica 7, 4 (2020), 280-283.
16. Ayan Chakrabarti. 2016. Learning sensor multiplexing design through back-propagation. Advances in Neural Information Processing Systems 29 (2016).
17. Julie Chang and Gordon Wetzstein. 2019. Deep Optics for Monocular Depth Estimation and 3D Object Detection. ArXiv abs/1904.08601 (2019).
18. Wei Ting Chen, Alexander Y Zhu, Vyshakh Sanjeev, Mohammadreza Khorasaninejad, Zhujun Shi, Eric Lee, and Federico Capasso. 2018. A broadband achromatic metalens for focusing and imaging in the visible. Nature Nanotechnology 13, 3 (2018), 220-226.
19. Gene Chou, Yuval Bahat, and Felix Heide. 2022. Diffusion-SDF: Conditional Generative Modeling of Signed Distance Functions. arXiv preprint arXiv: 2211.13757 (2022).
20. Ilya Chugunov, Seung-Hwan Baek, Qiang Fu, Wolfgang Heidrich, and Felix Heide. 2021. Mask-ToF: Learning Microlens Masks for Flying Pixel Correction in Time-of-Flight Imaging. In Proceedings of the IEEE/CVF Conference on Computer Vision and Pattern Recognition. 9116-9126.
21. Shane Colburn and Arka Majumdar. 2020. Metasurface generation of paired accelerating and rotating optical beams for passive ranging and scene reconstruction. ACS Photonics 7, 6 (2020), 1529-1536.
22. Shane Colburn, Alan Zhan, and Arka Majumdar. 2018. Metasurface optics for full-color computational imaging. Science Advances 4 (2018), eaar2114.
23. Jia Deng, Wei Dong, Richard Socher, Li-Jia Li, Kai Li, and Li Fei-Fei. 2009. Imagenet: A large-scale hierarchical image database. In 2009 IEEE conference on computer vision and pattern recognition. Ieee, 248-255.
24. Jacob Engelberg and Uriel Levy. 2020. The advantages of metalenses over diffractive lenses. Nature Communications 11 (2020), 1991.
25. MohammadSadegh Faraji-Dana, Ehsan Arbabi, Hyounghan Kwon, Seyedeh Mahsa Kamali, Amir Arbabi, John G Bartholomew, and Andrei Faraon. 2019. Hyperspectral imager with folded metasurface optics. ACS Photonics 6, 8 (2019), 2161-2167.
26. A. Foi, Mejdi Trimeche, V. Katkovnik, and K. Egiazarian. 2008. Practical Poissonian-Gaussian Noise Modeling and Fitting for Single-Image Raw-Data. IEEE Transactions on Image Processing 17 (2008), 1737-1754.
27. Alice Fontbonne, Hervé Sauer, and François Goudail. 2022. End-to-end optimization of optical systems with extended depth of field under wide spectrum illumination. Applied Optics 61, 18 (2022), 5358-5367.
28. Carl Friedrich Gauss. 1843. Dioptrische Untersuchungen von CF Gauss. in der Dieterichschen Buchhandlung.
29. Gene H Golub, Per Christian Hansen, and Dianne P O'Leary. 1999. Tikhonov regularization and total least squares. SIAM journal on matrix analysis and applications 21, 1 (1999), 185-194.
30. Harel Haim, Shay Elmalem, Raja Giryes, Alex Bronstein, and Emanuel Marom. 2018. Depth Estimation From a Single Image Using Deep Learned Phase Coded Mask. IEEE Transactions on Computational Imaging 4 (2018), 298-310.
31. Lei He, Guanghui Wang, and Zhanyi Hu. 2018. Learning Depth From Single Images With Deep Neural Network Embedding Focal Length. IEEE Transactions on Image Processing 27 (2018), 4676-4689.
32. Felix Heide, Qiang Fu, Yifan Peng, and Wolfgang Heidrich. 2016. Encoded diffractive optics for full-spectrum computational imaging. Scientific reports 6 (2016), 33543.
33. Felix Heide, Mushfiqur Rouf, Matthias B Hullin, Bjorn Labitzke, Wolfgang Heidrich, and Andreas Kolb. 2013. High-quality computational imaging through simple lenses. ACM Transactions on Graphics (SIGGRAPH) 32, 5 (2013), 1-14.
34. Jonathan Ho, Ajay Jain, and Pieter Abbeel. 2020. Denoising diffusion probabilistic models. Advances in Neural Information Processing Systems 33 (2020), 6840-6851.
35. Roarke Horstmeyer, Richard Y. Chen, Barbara Kappes, and Benjamin Judkewitz. 2017. Convolutional neural networks that teach microscopes how to image. ArXiv abs/1709.07223 (2017).
36. Michael Kellman, Emrah Bostan, Michael Chen, and Laura Waller. 2019. Data-Driven Design for Fourier Ptychographic Microscopy. In 2019 IEEE International Conference on Computational Photography (ICCP). IEEE, 1-8.
37. Salman Siddique Khan, Varun Sundar, Vivek Boominathan, Ashok Veeraraghavan, and Kaushik Mitra. 2020. Flatnet: Towards photorealistic scene reconstruction from lensless measurements. IEEE Transactions on Pattern Analysis and Machine Intelligence (2020).
38. Mohammadreza Khorasaninejad, Zhujun Shi, Alexander Y Zhu, Wei-Ting Chen, Vyshakh Sanjeev, Aun Zaidi, and Federico Capasso. 2017. Achromatic metalens over 60 nm bandwidth in the visible and metalens with reverse chromatic dispersion. Nano Letters 17, 3 (2017), 1819-1824.
39. Oliver Kingshott, Nick Antipa, Emrah Bostan, and Kaan Akşit. 2022. Unrolled primal-dual networks for lensless cameras. Opt. Express 30, 26 (December 2022), 46324-46335. https://doi.org/10.1364/OE.475521
40. Grace Kuo, Nick Antipa, Ren Ng, and Laura Waller. 2017. DiffuserCam: diffuser-based lensless cameras. In Computational Optical Sensing and Imaging. Optical Society of America, CTu3B-2.
41. Grace Kuo, Fanglin Linda Liu, Irene Grossrubatscher, Ren Ng, and Laura Waller. 2020. On-chip fluorescence microscopy with a random microlens diffuser. Optics express 28, 6 (2020), 8384-8399.
42. Rémi Laumont, Valentin De Bortoli, Andrés Almansa, Julie Delon, Alain Durmus, and Marcelo Pereyra. 2022. On Maximum-a-Posteriori estimation with Plug & Play priors and stochastic gradient descent. arXiv preprint arXiv: 2201.06133 (2022).
43. Xiu Li, Jinli Suo, Disclosed Weihang Zhang, Xin Yuan, and Qionghai Dai. 2021. Universal and flexible optical aberration correction using deep-prior based deconvolution. In Proceedings of the IEEE/CVF International Conference on Computer Vision. 2613-2621.
44. Dianmin Lin, Pengyu Fan, Erez Hasman, and Mark L. Brongersma. 2014. Dielectric gradient metasurface optical elements. Science 345, 6194 (2014), 298-302. https://doi.org/10.1126/science.1253213
45. Zin Lin, Charles Roques-Carmes, Raphaël Pestourie, Marin Soljačić, Arka Majumdar, and Steven G. Johnson. 2021. End-to-end nanophotonic inverse design for imaging and polarimetry. Nanophotonics 10, 3 (2021), 1177-1187. https://doi.org/doi: 10.1515/nanoph-2020-0579
46. Fanglin Linda Liu, Vaishnavi Madhavan, Nick Antipa, Grace Kuo, Saul Kato, and Laura Waller. 2019. Single-shot 3D fluorescence microscopy with Fourier DiffuserCam. In Novel Techniques in Microscopy. Optica Publishing Group, NS2B-3.
47. Leon B Lucy. 1974. An iterative technique for the rectification of observed distributions. The astronomical journal 79 (1974), 745.
48. Joseph N. Mait, Ravindra A. Athale, Joseph van der Gracht, and Gary W. Euliss. 2020. Potential Applications of Metamaterials to Computational Imaging, In Proc. Frontiers in Optics/Laser Science. Frontiers in Optics/Laser Science, FTu8B.1. https://doi.org/10.1364/FIO.2020.FTu8B.1
49. Julio Marco, Quercus Hernandez, Adolfo Muñoz, Yue Dong, Adrián Jarabo, Min H. Kim, Xin Tong, and Diego Gutierrez. 2017. DeepToF: off-the-shelf real-time correction of multipath interference in time-of-flight imaging. ACM Trans. Graph. 36 (2017), 219:1-219:12.
50. Christopher A Metzler, Hayato Ikoma, Yifan Peng, and Gordon Wetzstein. 2020. Deep optics for single-shot high-dynamic-range imaging. In Proceedings of the IEEE/CVF Conference on Computer Vision and Pattern Recognition. 1375-1385.
51. Kristina Monakhova, Kyrollos Yanny, Neerja Aggarwal, and Laura Waller. 2020. Spectral DiffuserCam: lensless snapshot hyperspectral imaging with a spectral filter array. Optica 7, 10 (2020), 1298-1307.
52. A. Ndao, Li-Yi Hsu, Jeongho Ha, Junhee Park, C. Chang-Hasnain, and B. Kanté. 2020. Octave bandwidth photonic fishnet-achromatic-metalens. Nature Communications 11 (2020), 3205.
53. Elias Nehme, Daniel Freedman, Racheli Gordon, Boris Ferdman, Lucien E Disclosed embodimentsiss, Onit Alalouf, Tal Naor, Reut Orange, Tomer Michaeli, and Yoav Shechtman. 2020. Deep-STORM3D: dense 3D localization microscopy and PSF design by deep learning. Nature methods 17, 7 (2020), 734-740.
54. Yifan Peng, Qiang Fu, Hadi Amata, Shuochen Su, Felix Heide, and Wolfgang Heidrich. 2015. Computational imaging using lightweight diffractive-refractive optics. Optics Express 23 (2015), 31393-31407.
55. Yifan Peng, Qiang Fu, Felix Heide, and Wolfgang Heidrich. 2016a. The Diffractive Achromat: Full Spectrum Computational Imaging with Diffractive Optics. ACM Trans. Graph. (SIGGRAPH ASIA 2016) 35, 4, Article 31 (July 2016), 11 pages.
56. Yifan Peng, Qiang Fu, Felix Heide, and Wolfgang Heidrich. 2016b. The Diffractive Achromat Full Spectrum Computational Imaging with Diffractive Optics. ACM Transactions on Graphics (TOG) 35 (2016), 1-11.
57. Yifan Peng, Qilin Sun, Xiong Dun, Gordon Wetzstein, Wolfgang Heidrich, and Felix Heide. 2019a. Learned Large Field-of-View Imaging With Thin-Plate Optics. ACM Transactions on Graphics (SIGGRAPH Asia) 38, 6 (2019).
58. Yifan Peng, Qilin Sun, Xiong Dun, Gordon Wetzstein, Wolfgang Heidrich, and Felix Heide. 2019b. Learned large field-of-view imaging with thin-plate optics. ACM Transactions on Graphics (TOG) 38 (2019), 1-14.
59. Yifan Peng, Qilin Sun, Xiong Dun, Gordon Wetzstein, Wolfgang Heidrich, and Felix Heide. 2019c. Learned large field-of-view imaging with thin-plate optics. ACM Trans. Graph. (Proc. Siggraph Asia) 38, 6 (2019), 219-1.
60. Federico Presutti and Francesco Monticone. 2020a. Focusing on bandwidth: achromatic metalens limits. Optica 7, 6 (2020), 624-631.
61. Federico Presutti and Francesco Monticone. 2020b. Focusing on bandwidth: achromatic metalens limits. Optica 7, 6 (June 2020), 624-631. https://doi.org/10.1364/OPTICA.389404
62. William Hadley Richardson. 1972. Bayesian-based iterative method of image restoration. JoSA 62, 1 (1972), 55-59.
63. Yaniv Romano, Michael Elad, and Peyman Milanfar. 2017. The little engine that could: Regularization by denoising (RED). SIAM Journal on Imaging Sciences 10, 4 (2017), 1804-1844.
64. Olaf Ronneberger, Philipp Fischer, and Thomas Brox. 2015. U-Net: Convolutional Networks for Biomedical Image Segmentation. In Proc. Medical Image Computing and Computer-Assisted Intervention (MICCAI).
65. C. Schuler, H. Burger, S. Harmeling, and B. Schölkopf. 2013. A Machine Learning Approach for Non-blind Image Deconvolution. In Proc. IEEE Conference on Computer Vision and Pattern Recognition (CVPR). 1067-1074.
66. Yoav Shechtman, Lucien E Weiss, Adam S. Backer, Maurice Y. Lee, and W E Moerner. 2016. Multicolour localization microscopy by point-spread-function engineering. Nature photonics 10 (2016), 590-594.
67. Zheng Shi, Yuval Bahat, Seung-Hwan Baek, Qiang Fu, Hadi Amata, Xiao Li, Praneeth Chakravarthula, Wolfgang Heidrich, and Felix Heide. 2022. Seeing through Obstructions with Diffractive Cloaking. ACM Transactions on Graphics (SIGGRAPH) 41, 4 (2022).
68. Sajan Shrestha, Adam C. Overvig, Ming Ying Lu, Aaron Stein, and Nanfang Yu. 2018. Broadband achromatic dielectric metalenses. Light: Science & Applications 7 (2018), 85.
69. Vincent Sitzmann, Steven Diamond, Yifan Peng, Xiong Dun, Stephen Boyd, Wolfgang Heidrich, Felix Heide, and Gordon Wetzstein. 2018. End-to-end optimization of optics and image processing for achromatic extended depth of field and super-resolution imaging. ACM Trans. Graph. (TOG) 37, 4 (2018), 114.
70. Jascha Sohl-Dickstein, Eric Weiss, Niru Maheswaranathan, and Surya Ganguli. 2015. Deep unsupervised learning using nonequilibrium thermodynamics. In International Conference on Machine Learning. PMLR, 2256-2265.
71. Jiaming Song, Chenlin Meng, and Stefano Ermon. 2021. Denoising Diffusion Implicit Models. In International Conference on Learning Representations. https://openreview.net/forum?id=St1giarCHLP
72. David Stork and Patrick Gill. 2014. Optical, mathematical, and computational foundations of lensless ultra-miniature diffractive imagers and sensors. International Journal on Advances in Systems and Measurements 7, 3 (2014), 4.
73. Shuochen Su, Felix Heide, Gordon Wetzstein, and Wolfgang Heidrich. 2018. Deep End-to-End Time-of-Flight Imaging. 2018 IEEE/CVF Conference on Computer Vision and Pattern Recognition (2018), 6383-6392.
74. Qilin Sun, Ethan Tseng, Qiang Fu, Wolfgang Heidrich, and Felix Heide. 2020. Learning Rank-1 Diffractive Optics for Single-shot High Dynamic Range Imaging. In The IEEE Conference on Computer Vision and Pattern Recognition (CVPR).
75. Qilin Sun, Congli Wang, Fu Qiang, Dun Xiong, and Heidrich Wolfgang. 2021. End-to-end complex lens design with differentiable ray tracing. ACM Transactions on Graphics (Proc. Siggraph) 40, 4 (2021), 1-13.
76. Jun Tanida, Tomoya Kumagai, Kenji Yamada, Shigehiro Miyatake, Kouichi Ishida, Takashi Morimoto, Noriyuki Kondou, Daisuke Miyazaki, and Yoshiki Ichioka. 2001. Thin observation module by bound optics (TOMBO): concept and experimental verification. Applied optics 40, 11 (2001), 1806-1813.
77. Ethan Tseng, Shane Colburn, James Whitehead, Luocheng Huang, Seung-Hwan Baek, Arka Majumdar, and Felix Heide. 2021a. Neural Nano-Optics for High-quality Thin Lens Imaging. Nature Communications (December 2021).
78. Ethan Tseng, Ali Mosleh, Fahim Mannan, Karl St-Arnaud, Avinash Sharma, Yifan Peng, Alexander Braun, Derek Nowrouzezahrai, Jean-Francois Lalonde, and Felix Heide. 2021b. Differentiable Compound Optics and Processing Pipeline Optimization for End-to-end Camera Design. ACM Transactions on Graphics (SIGGRAPH) 40, 4 (2021).
79. Ashish Vaswani, Noam Shazeer, Niki Parmar, Jakob Uszkoreit, Llion Jones, Aidan N Gomez, Łukasz Kaiser, and Illia Polosukhin. 2017. Attention is all you need. Advances in neural information processing systems 30 (2017).
80. Singanallur V Venkatakrishnan, Charles A Bouman, and Brendt Wohlberg. 2013. Plug-and-play priors for model based reconstruction. In 2013 IEEE Global Conference on Signal and Information Processing. IEEE, 945-948.
81. Kartik Venkataraman, Dan Lelescu, Jacques Duparré, Andrew McMahon, Gabriel Molina, Priyam Chatterjee, Robert Mullis, and Shree Nayar. 2013. Picam: An ultra-thin high performance monolithic camera array. ACM Trans. Graph. (TOG) 32, 6 (2013), 166.
82. Shuming Wang, Pin Chieh Wu, Vin-Cent Su, Yi-Chieh Lai, Mu-Ku Chen, Hsin Yu Kuo, Bo Han Chen, Yu Han Chen, Tzu-Ting Huang, Jung-Hsi Wang, et al. 2018a. A broadband achromatic metalens in the visible. Nature nanotechnology 13, 3 (2018), 227-232.
83. Shuming Wang, Pin Chieh Wu, Vin-Cent Su, Yi-Chieh Lai, Mu-Ku Chen, Hsin Yu Kuo, Bo Han Chen, Yu Han Chen, Tzu-Ting Huang, Jung-Hsi Wang, Ray-Ming Lin, Chieh-Hsiung Kuan, Tao Li, Zhen lin Wang, Shining Zhu, and Din Ping Tsai. 2018b. A broadband achromatic metalens in the visible. Nature Nanotechnology 13 (2018), 227-232.
84. Shuming Wang, Pin Chieh Wu, Vin-Cent Su, Yi-Chieh Lai, Cheng Hung Chu, Jia-Wern Chen, Shen-Hung Lu, Ji Chen, Beibei Xu, Chieh-Hsiung Kuan, et al. 2017. Broadband achromatic optical metasurface devices. Nature Communications 8, 1 (2017), 187.
85. Alexander D. White, Parham Porsandeh Khial, Fariborz Salehi, Babak Hassibi, and Ali Hajimiri. 2020. A Silicon Photonics Computational Lensless Active-Flat-Optics Imaging System. Scientific Reports 10 (2020), 1689.
86. Norbert Wiener, Norbert Wiener, Cyberneticist Mathematician, Norbert Wiener, Norbert Wiener, and Cybernéticien Mathématicien. 1949. Extrapolation, interpolation, and smoothing of stationary time series: with engineering applications. Vol. 113. MIT press Cambridge, MA.
87. Yicheng Wu, Vivek Boominathan, Huaijin Chen, Aswin Sankaranarayanan, and Ashok Veeraraghavan. 2019. PhaseCam3D—Learning Phase Masks for Passive Single View Depth Estimation. 2019 IEEE International Conference on Computational Photography (ICCP) (2019), 1-12.
88. Kyrollos Yanny, Kristina Monakhova, Richard W Shuai, and Laura Waller. 2022. Deep learning for fast spatially varying deconvolution. Optica 9, 1 (2022), 96-99.
89. Nanfang Yu and Federico Capasso. 2014. Flat optics with designer metasurfaces. Nature Materials 13 (2014), 139-150.
90. Richard Zhang, Phillip Isola, Alexei A. Efros, Eli Shechtman, and Oliver Wang. 2018. The unreasonable effectiveness of deep features as a perceptual metric. In Proc. IEEE International Conference on Computer Vision and Pattern Recognition (CVPR).
91. Xuaner Zhang, Qifeng Chen, Ren Ng, and Vladlen Koltun. 2019. Zoom to learn, learn to zoom. In Proceedings of the IEEE/CVF Conference on Computer Vision and Pattern Recognition. 3762-3770.
92. Guoxing Zheng, Holger Mühlenbernd, Mitchell Kenney, Guixin Li, Thomas Zentgraf, and Shuang Zhang. 2015. Metasurface holograms reaching 80% efficiency. Nature Nanotechnology 10 (2015), 308-312.
93. You Zhou, Hanyu Zheng, Ivan I Kravchenko, and Jason Valentine. 2020. Flat optics for image differentiation. Nature Photonics 14, 5 (2020), 316-323.

All documents, patents, journal articles and other materials cited in the present application are incorporated herein by reference.

While the present disclosure has been disclosed with references to certain embodiments, numerous modification, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims, and equivalents thereof.

What is claimed is:

1. An imaging system comprising:
a metalens array camera having a central element;
a reference camera having a reference camera sensor; and
a beam splitter,
wherein the beam splitter splits light into two optical paths by 70% transmission and 30% reflection,
wherein the beam splitter is positioned at a 45° tilting angle,
wherein the transmission path is incident of a center of the central element, wherein a center of the reference camera is positioned in the reflection path and a distance between the beam splitter and the reference camera sensor is adjusted to the same as that between the beam splitter and the metalens array camera,
wherein an optical center and an optical axis of the central element of the metalens array camera is aligned to an optical center and an optical axis of the reference camera,
wherein the metalens array camera and the reference camera are synchronized to capture scenes with a same timestamps.

2. The imaging system of claim 1, wherein the metalens array camera comprises a flat on-sensor nanophotonic array lens.

3. The imaging system of claim 1, wherein the imaging system is mounted on a tripod with rollers.

4. The imaging system of claim 1, wherein a Precision Time Protocol (PTP) is used to synchronize the metalens array camera and the reference camera.

5. The imaging system of claim 1, wherein the imaging system is configured to capture images at slanted field angles at a wide field of view of 100°.

6. The imaging system of claim 1,
wherein the metalens array camera comprises an array of nanophotonic optics, wherein the array of nanophotonic optics are learned for a broadband spectrum;
wherein the imaging system further comprises a computational reconstruction module that is configured to recover a single megapixel image from an array of measurements;
a metalens array camera sensor;
a sensor cover glass; and
a single flat optical layer disposed on top of the sensor cover glass at approximately 2.5 mm focal distance from the metalens array camera sensor.

7. The imaging system claim 6,
wherein the array of nanophotonic optics comprises lenses,
wherein each lens is a flat metasurface area of nano-antennas designed to focus light across a visible spectrum.

8. A method of designing an array over an image sensor comprising:
applying a differentiable optimization method that continuously samples over a visible spectrum;
factorizing an optical modulation for different incident fields into individual lenes of a nanophotonic imager having a learned array of metalenses for capturing a scene;
measuring an array of images, each having a different field of view (FoV); and
deconvolving the array of images and merging them together to form a wider FoV image.

9. The method of claim 8 further comprising:
configuring a computational reconstruction module to recover a single megapixel image from an array of measurements.

10. The method of claim 8, wherein a training for the deconvolving is performed iteratively and progressively to sample over a plausible manifold of latent images from sensor measurements.

11. The method of claim 10, wherein a dataset with groundtruth images of 800×800 resolution and 9 patches of 420×420 sub-images measured from individual metalenses in a nanophotonic array is utilized for training.

12. The method of claim 11, wherein the training utilizes the paired groundtruth and metalens array measurements acquired from a paired-camera setup.

13. The method of claim 12, wherein the paired-camera setup comprises:
a metalens array camera having a central element;
a reference camera having a reference camera sensor; and
a beam splitter,
wherein the beam splitter splits light into two optical paths by 70% transmission and 30% reflection,
wherein the beam splitter is positioned at a 45° tilting angle,
wherein the transmission path is incident of a center of the central element,
wherein a center of the reference camera is positioned in the reflection path and a distance between the beam splitter and the reference camera sensor is adjusted to the same as that between the beam splitter and the metalens array camera,
wherein an optical center and an optical axis of the central element of the metalens array camera is aligned to an optical center and an optical axis of the reference camera,
wherein the metalens array camera and the reference camera are synchronized to capture scenes with a same timestamps.

14. The method of claim 12, wherein the metalens array camera comprises a flat on-sensor nanophotonic array lens.

15. The method of claim 12, wherein a Precision Time Protocol (PTP) is used to synchronize the metalens array camera and the reference camera.

16. The method of claim 12, wherein the paired-camera setup is configured to capture images at slanted field angles at a wide field of view of 100°.

17. The method of claim 11, wherein the dataset for training consists of simulated data and captured paired image data.

18. The method of claim 11, wherein the simulated data is produced by simulating a nanophototonic array camera with corresponding metalens design parameters to generate a synthetic dataset of paired on-sensor and groundtruth measurements.

19. The method of claim 18, wherein the synthetic dataset is utilized for training alongside a dataset for fine-tuning.

20. The method of claim 19, wherein the synthetic dataset is comparatively larger than the dataset.
